(19) United States
(12) Patent Application Publication
(10) Pub. No.: US 2025/0268271 A1
(43) Pub. Date: Aug. 28, 2025

(54) COMPOSITION OF RECOMBINANT CASEINS AND PLANT MATERIAL

(71) Applicant: PLANTOPIA LTD., Caesarea (IL)

(72) Inventors: Tal LUTZKY, Haifa (IL); Amir TIROLER, Hadera (IL); Elena GREENFELD, Karmiel (IL); Irina PORTNAYA, Nesher (IL)

(21) Appl. No.: 19/202,578

(22) Filed: May 8, 2025

Related U.S. Application Data
(63) Continuation of application No. PCT/IL2024/051069, filed on Nov. 7, 2024.

(30) Foreign Application Priority Data
Nov. 9, 2023 (IL) 308452

(51) Int. Cl. A23C 11/06; A23C 20/00; A23J 3/10; A23J 3/14

(52) U.S. Cl. CPC A23C 11/06; A23C 20/00; A23J 3/10; A23J 3/14

(57) ABSTRACT

The present invention is directed to a composition including: (a) a micelle dispersed in an aqueous solution, wherein the micelle includes recombinant proteins of αS1 Casein, αS2 Casein, β Casein, and κ Casein; (b) and a plant derived material. Further provided is a method for preparing the composition. Some of the present embodiments of the disclosure are directed to a composition comprising a plurality of micelles, wherein each of the plurality of micelles includes a plant-based protein, where in the plant-based protein comprises: α Casein, β Casein, and κ Casein; a plant derived material; calcium ions; and phosphate ions. Further provided are methods for preparing analog food products comprising the composition(s) of the disclosure.

### CROSS-REFERENCE TO RELATED APPLICATIONS

This application is a U.S. continuation application of co-pending International Patent Application No. PCT/IL2024/051069, filed Nov. 7, 2024, which claims the benefit of Israeli Patent Application No. 308452, titled “COMPOSITION OF RECOMBINANT CASEINS AND PLANT MATERIAL”, filed 9 Nov. 2023, the contents of each of the foregoing are incorporated herein by reference in their entirety.

### FIELD

Embodiments of the present disclosure are in the field of recombinant proteins and use of same for production of milk-like micelles in the presence of plant material.

### BACKGROUND

Bovine milk constitutes a major segment of the global dairy market—estimated at approximately $1 billion in the United States, while plant-based milk alternatives, though expanding, remain comparatively limited and account for an estimated $700 million. Bovine milk is characterized by the presence of primary casein proteins: α-casein (S1, S2), β-casein, and κ-casein. These proteins, along with a diverse array of other components, contribute to the complex biochemical profile of mammalian milk.

Despite its comprehensive nutritional profile, bovine (and other mammalian) milk is increasingly substituted with plant- or nut-based alternatives such as soy, almond, and coconut milk. The motivations for this shift include allergenicity to dairy proteins, lactose intolerance, dietary preferences, and concerns about the ecological impact of dairy production. However, while these alternatives may offer perceived health and environmental advantages, they are compositionally and functionally distinct from bovine milk and lack many of its physicochemical properties. In particular, plant-based milk alternatives fail to replicate the structural and functional characteristics necessary for producing complex dairy-derived products such as cheese, yogurt, butter, and cream. These functionalities are largely dependent on casein micelle formation and the behavior of milk proteins under processing conditions—features that are largely absent in current non-dairy analogs.

As a result, there remains a significant unmet need for alternative dairy compositions that can closely emulate both the sensory attributes and functional performance of bovine-derived dairy products.

### SUMMARY

According to the first aspect, there is provided a composition comprising: (a) a micelle dispersed in an aqueous solution, wherein the micelle comprises recombinant proteins of αS Casein, β Casein, and κ Casein; and (b) a plant derived material.

According to another aspect, there is provided a method for preparing the composition of the invention, the method comprising mixing recombinant proteins of αS Casein, β Casein, and κ Casein; and a plant derived material, thereby preparing the composition.

In some embodiments, the recombinant proteins of αS Casein, β Casein, and κ Casein, are present in the composition in a weight per weight ratio (w/w) of between 2:2:1 to 6:6:1.

In some embodiments, the αS Casein comprises: αS1 Casein, αS2 Casein, or both.

In some embodiments, the recombinant proteins are plant-based recombinant proteins.

In some embodiments, the plant derived material comprises an extract, a homogenate, any fraction thereof, or any combination thereof, being derived from a plant.

In some embodiments, the composition further comprises calcium ions.

In some embodiments, the calcium ions are present in the composition in a concentration ranging from 2 mM to 100 mM.

In some embodiments, the calcium ions are present in said composition in the form of CaCl₂.

In some embodiments, the composition further comprises phosphate ions, polyphosphate ions, or a combination thereof.

In some embodiments, the composition further comprises at least one ion selected from the group consisting of: Zn²⁺, Mg²⁺, Cu²⁺, Na⁺, K⁺, Fe²⁺, Fe³⁺, and any combination thereof.

In some embodiments, the composition comprises a plurality of micelles of the micelle, and being characterized by an average Zeta potential ranging between −17 and −6 mV. In some embodiments, the composition, dry dairy substitute composition, or powdered plurality of micelles when diluted to 1% or greater (e.g., 1.5, 2.5, 3.5, 4.5, 5.5), 5% or less (e.g., 4, 3, 2, 1), or 1%-5% (e.g., 1.5%-4.5%; 2%-4%, 3%-3.5%), comprises an average Zeta potential of −17 mV or greater (e.g., −15, −13, −11, −9, −7, −5, −3, −1, 1, 3, 5, 7, 9, 11); 10 mV or less (e.g., 8, 6, 4,2, 0, −2, −4, −6, −8, −10, −12, −14, −16, −18, −20); or −17 mV-10 mV (e.g., −16 mV-9 mV; −15 mV-8 mV; −14 mV-7 mV; −13 mV-6 mV; −12 mV-5 mV; −11 mV-4 mV; −10 mV-3 mV; −9 mV-2 mV; −8 mV-1 mV; −7 mV-0 mV; −6 mV-−1 mV; −5 mV-−2 mV; −4 mV-−3 mV).

In some embodiments, the composition is characterized by an average Zeta potential ranging between −14 and −8 mV.

In some embodiments, the compositions of the disclosure comprising a dry dairy substitute composition comprising plurality of micelles is characterized by an average particle size ranging between 100 nm and 250 nm, 300 nm and 500 nm, or both. In some embodiments, the average particle size was 100 nm or greater (e.g., 200, 300, 400, 500, 600, 700, 800, 900, 1000); 1000 nm or less (e.g., 950, 850, 750, 650, 550, 450, 350, 250, 150, 50); 100 nm-1000 nm (e.g., 125 nm-975 nm; 150 nm-950 nm; 175 nm-925 nm; 200 nm-900 nm; 225 nm-875 nm; 250 nm-850 nm; 275 nm-825 nm; 300 nm-800 nm; 325 nm-775 nm; 350 nm-750 nm; 375 nm-725 nm; 400 nm-700 nm; 425 nm-675 nm; 450 nm-650 nm; 475 nm-625 nm; 500 nm- 600 nm).

In some embodiments, the micelle is essentially similar to a micelle of milk, optionally wherein the milk is bovine milk.

In some embodiments, the plurality of micelles is characterized by any one of: having size, average size, or maximal size, diameter, average diameter, or maximal diameter, taste, flavor, scent, organoleptic properties, and any combination thereof, being at least 90% identical to milk micelles.

In some embodiments, the method comprises obtaining a plurality of micelles dispersed in an aqueous solution, wherein each micelle of the plurality of micelles comprises the recombinant proteins of αS Casein, β Casein, and κ Casein.

In some embodiments, the recombinant proteins of αS Casein, β Casein, and κ Casein are mixed in a final a weight per weight ratio (w/w) of between 2:2:1 to 6:6:1 in the plurality of micelles of the composition.

In some embodiments, the mixing is in the presence of at least one ion selected from the group consisting of: Ca²⁺, phosphate, polyphosphate, Zn²⁺, Mg²⁺, Cu²⁺, Na⁺, K⁺, Fe²⁺, Fe³⁺, and any combination thereof.

In some embodiments, the mixing comprises mixing under at least one condition selected from the group consisting of: heat, cooling, sonication, electrolysis, and any combination thereof.

In some embodiments, the recombinant proteins of the plurality of micelles of the composition are plant-based recombinant proteins.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIGS. 1A-1C include graphs showing a DLS study of individual α Casein (1A), β Casein (1B), and κ Casein (1C).

FIGS. 2A-2C include graphs showing an isothermal titration calorimetry (ITC) study showing critical micelle concentration of individual α Casein (2A), β Casein (2B), and κ Casein (2C).

FIG. 3 includes graphs showing an ITC study of titration of α Casein into β Casein.

FIG. 4 includes graphs of an ITC study showing micelle assembly obtained by addition of κ Casein into a mixture of α Casein into β Casein.

FIG. 5 includes tables and a graph of a DLS study showing assembly of all four caseins (αS1 Casein, αS2 Casein, β Casein, and κ Casein) into micelles (without further additives).

FIGS. 6A-6B include graphs and a table of an ITC (6A) and DLS (6B) studies showing assembly of all four caseins (αS1 Casein, αS2 Casein, β Casein, and κ Casein) into micelles. Saturated calcium phosphate solution was titrated into the casein mixture.

FIGS. 7A-7B include graphs and a table of an ITC (7A) and DLS (7B) studies showing assembly of all four caseins (αS1 Casein, αS2 Casein, β Casein, and κ Casein) into micelles. Casein mixture was titrated into a saturated calcium phosphate solution.

FIGS. 8A-8D include graphs of DLS studies testing the effect of different sources of calcium ions on the assembly of all four caseins (αS1 Casein, αS2 Casein, β Casein, and κ Casein) into micelles. (8A) Caseins only; (8B) Caseins with calcium phosphate; (8C) Caseins with calcium chloride; and (8D) Caseins with calcium chloride and calcium phosphate.

FIG. 9 includes photographs and an image of western blot analysis showing the effect of heat treatment and the addition of food grade salts in the assembly of all four caseins (αS1 Casein, αS2 Casein, β Casein, and κ Casein) into micelles. A—Casein solution only; B—Caseins solution with the additions of salts; M—molecular size marker.

FIG. 10 includes graphs and a table of a DLS study showing the effect of heat treatment and the addition of food grade salts in the assembly of all four caseins (αS1 Casein, αS2 Casein, β Casein, and κ Casein) into micelles.

FIG. 11 includes a table, a graph, and a photograph of a Nile red staining assay showing the effect of added salts on the assembly of all four caseins (αS1 Casein, αS2 Casein, β Casein, and κ Casein) into micelles.

FIG. 12 includes a table summarizing Zeta potential measurements of individual caseins, and of micelles including all caseins (αS1 Casein, αS2 Casein, β Casein, and κ Casein) formed in the presence of additives.

FIG. 13 includes micrographs of cryogenic-transmission electron microscopy (TEM) showing micelles including all caseins (αS1 Casein, αS2 Casein, β Casein, and κ Casein) formed from in the presence of saturated calcium phosphate and 0.2% calcium chloride. Scale bar=0.5 μm (upper left), 200 nm (upper right), or 100 nm (bottom).

FIG. 14 includes a graph showing interaction of lettuce proteins with caseins and a possible effect on micellization.

FIGS. 15A-15C include graphs of an ITC study showing interactions of recombinant caseins with plant material in the absence (15A) or presence (15B-15C) of additives. (15A) all caseins (αS1 Casein, αS2 Casein, β Casein, and κ Casein) and lettuce extract; (15B) all caseins, lettuce extract, calcium phosphate, and calcium chloride; and (15C) all caseins, lettuce extract, and calcium chloride.

FIGS. 16A-16C include graphs of DLS study showing micellization of recombinant caseins in the presence of plant material and additives. (16A) Lettuce extract and calcium chloride; (16B) micellization of all caseins in a lettuce extract; and (16C) micellization of all caseins in a lettuce extract, and calcium chloride.

FIGS. 17A-17C include graphs of DLS study showing micellization of recombinant caseins in the presence of plant material and adjusted salt concentration. (17A) Micellization of all caseins in a lettuce extract; and (17B) micellization of all caseins in calcium phosphate and calcium chloride; and (17C) micellization of all caseins in a lettuce extract, and calcium chloride.

FIGS. 18A-18B include micrographs of cryogenic-TEM showing that micelles of recombinant caseins in a plant material mimic native milk micellization. (18A) Native milk micelles (Control); and (18B) micellization of all caseins in a lettuce extract, and calcium chloride. Scale bar=100 nm.

FIG. 19 includes a table summarizing the average size (nm) and Zeta potential (mV) of “milk-like” micelles or particles obtained with the following samples: (1) (α+β+κ)+Lettuce extract+0.1% CaCl₂ in phosphate buffer; (2) (α+β+κ)+Lettuce extract+0.2% CaCl₂ in phosphate buffer; (3) (α+β+κ)+Lettuce extract+0.25% CaCl₂ in phosphate buffer; and (4) Lettuce extract in phosphate buffer serving as Control.

FIG. 20 includes micrographs of cryogenic-TEM showing micelles, obtained from Noga lettuce expressing the four caseins. Scale bar=200 nm.

FIG. 21 includes a table of DLS studies and photographs showing the effect of the concentration of CaCl₂ on micellization. CaCl2 was applied in the concentrations of 0 mM (negative control), 18 mM, 45 mM, 72 mM, 90 mM, 108 mM, and 180 mM.

FIG. 22 includes a table of DLS studies and photographs showing the effect of the concentration of lettuce material on micellization. Noga lettuce material was applied in the concentrations of 0.742%, 1.484%, 2.968%, 4.452%, and 5.935%. 0% served as negative control.

FIG. 23 includes a table of DLS studies and a photograph showing the effect of the concentration of oat material on micellization. Oat material was applied in the concentrations of 0.742%, 1.484%, 2.226%, 2.968%, 4.452%, and 5.935%. 0% served as negative control.

### DETAILED DESCRIPTION

The disclosure is based, at least in part, on the discovery that plant-based casein proteins and plant-derived materials form micelle-like structures, which can be used as a dairy substitute. Other features and advantages of the embodiments of the disclosure will be apparent from the detailed description and claims.

### Composition

According to the first aspect, there is provided a composition comprising: (a) a micelle dispersed in an aqueous solution, wherein the micelle comprises at least one recombinant casein protein; and (b) a plant derived material.

In some embodiments, the aqueous solution is or comprises a medium. As used herein, the terms “solution” and “medium” are interchangeable.

In some embodiments, the at least one recombinant casein protein is selected from: αS Casein, β Casein, κ Casein, or any combination thereof. In some embodiments, the at least one recombinant casein protein comprises αS Casein and β Casein. In some embodiments, the at least one recombinant casein protein comprises αS Casein and κ Casein. In some embodiments, the at least one recombinant casein protein comprises αS Casein, β Casein, and κ Casein.

In some embodiments, αS Casein comprises: αS1 Casein, αS2 Casein, or both.

In some embodiments, the at least one recombinant casein comprises: αS1 Casein, αS2 Casein, β Casein, and κ Casein.

In some embodiments, the composition comprises (a) a micelle dispersed in an aqueous solution, wherein the micelle comprises recombinant αS1 Casein, αS2 Casein, β Casein, and κ Casein proteins; and (b) a plant derived material.

In some embodiments, the composition comprises recombinant αS1 Casein, αS2 Casein, β Casein, and κ Casein proteins; and (b) a plant derived material.

In some embodiments, the recombinant protein comprises an amino acid sequence of a mammal casein. In some embodiments, the mammal is a domesticated mammal. In some embodiments, the mammal is a livestock mammal. In some embodiments, the livestock is or comprises bovine (Bos taurus). In some embodiments, a mammal comprises or is a human subject. In some embodiments, the recombinant protein comprises an amino acid sequence of a bovine casein or an analog thereof having at least 70%, 80%, 90%, 95%, or 99% sequence homology or identity thereto, or any value and range therebetween. Each possibility represents a separate embodiment of the invention.

The amino acid sequence of mammal caseins would be apparent to one of ordinary skill in the art, such as provided in the Uniprot.

In some embodiments, bovine αS1 Casein comprises an amino acid sequence as disclosed in protein primary accession no. P02662, or an analog thereof having at least 70%, 80%, 90%, 95%, or 99% sequence homology or identity thereto, or any value and range therebetween. Each possibility represents a separate embodiment of the invention.

In some embodiments, bovine, αS2 Casein comprises an amino acid sequence as disclosed in protein primary accession no. P02663, or an analog thereof having at least 70%, 80%, 90%, 95%, or 99% sequence homology or identity thereto, or any value and range therebetween. Each possibility represents a separate embodiment of the invention.

In some embodiments, bovine β Casein comprises an amino acid sequence as disclosed in protein primary accession no. P02666, or an analog thereof having at least 70%, 80%, 90%, 95%, or 99% sequence homology or identity thereto, or any value and range therebetween. Each possibility represents a separate embodiment of the invention.

In some embodiments, bovine κ Casein comprises an amino acid sequence as disclosed in protein primary accession no. P02668, or an analog thereof having at least 70%, 80%, 90%, 95%, or 99% sequence homology or identity thereto, or any value and range therebetween. Each possibility represents a separate embodiment of the invention.

In some embodiments, the micelle comprises the recombinant proteins of αS Casein, β Casein, and κ Casein, in a weight per weight ratio (w/w) of between 1:1:1 to 10:10:1, 2:2:1 to 10:10:1, 3:3:1 to 10:10:1, 4:4:1 to 10:10:1, 5:5:1 to 10:10:1, 6:6:1 to 10:10:1, 7:7:1 to 10:10:1, 1:1:4 to 8:8:1, 2:2:1 to 8:8:1, 3:3:1 to 5:5:1, 2:2:1 to 6:6:1, or 2:2:1 to 9:9:1. Non-limiting examples of ratios of the plant-based proteins of the disclosure in a weight per weight ratio (w/w) of α Casein, β Casein, and κ Casein include: 10:10:1; 8:8:1; 6:6:1; 6:2:1; 5:4:1; 2:6:1; 2:2:1; 1:1:4; 1:1:1; and any ratios therebetween. Each possibility represents a separate embodiment of the invention.

In some embodiments, the composition comprises the recombinant proteins of αS Casein, β Casein, and κ Casein, in a weight per weight ratio (w/w) of between 1:1:1 to 10:10:1, 2:2:1 to 10:10:1, 3:3:1 to 10:10:1, 4:4:1 to 10:10:1, 5:5:1 to 10:10:1, 6:6:1 to 10:10:1, 7:7:1 to 10:10:1, 2:2:1 to 8:8:1, 3:3:1 to 5:5:1, 2:2:1 to 6:6:1, or 2:2:1 to 9:9:1. Each possibility represents a separate embodiment of the invention.

In some embodiments, αS Casein comprises αS1 Casein and αS2 Casein in a weight per weight ratio between 3:1 to 1:3, 2:1 to 1:2, or is 1:1. Each possibility represents a separate embodiment of the invention.

As used herein, the term “recombinant protein” refers to a protein which is coded for by a recombinant DNA, and is thus not naturally occurring. The term “recombinant DNA” refers to DNA molecules formed by laboratory methods of genetic recombination. Generally, this recombinant DNA is in the form of a vector, plasmid or virus used to express the recombinant protein in a cell.

As used herein, the terms “peptide”, “polypeptide” and “protein” are used interchangeably to refer to a polymer of amino acid residues. In another embodiment, the terms “peptide”, “polypeptide” and “protein” as used herein encompass native peptides, peptidomimetics (typically including non-peptide bonds or other synthetic modifications) and the peptide analogues peptoids and semipeptoids or any combination thereof. In another embodiment, the peptides polypeptides and proteins described have modifications rendering them more stable while in the body or more capable of penetrating into cells. In one embodiment, the terms “peptide”, “polypeptide” and “protein” apply to naturally occurring amino acid polymers. In another embodiment, the terms “peptide”, “polypeptide” and “protein” apply to amino acid polymers in which one or more amino acid residue is an artificial chemical analogue of a corresponding naturally occurring amino acid.

The term “analog” as used herein, refers to a polypeptide that is similar, but not identical, to the polypeptide of the invention that still is capable of binding succinate or still comprises the succinate binding pocket. An analog may have deletions or mutations that result in an amino acids sequence that is different than the amino acid sequence of the polypeptide of the invention. It should be understood that all analogs of the polypeptide of the invention would still be capable of binding succinate or still comprise the succinate binding pocket. Further, an analog may be analogous to a fragment of the polypeptide of the invention, however, in such a case the fragment must comprise at least 50 consecutive amino acids of the polypeptide of the invention.

As used herein, the term “analog” includes any peptide having an amino acid sequence substantially identical to one of the sequences specifically shown herein in which one or more residues have been conservatively substituted with a functionally similar residue and which displays the abilities as described herein. Examples of conservative substitutions include the substitution of one non-polar (hydrophobic) residue such as isoleucine, valine, leucine or methionine for another, the substitution of one polar (hydrophilic) residue for another such as between arginine and lysine, between glutamine and asparagine, between glycine and serine, the substitution of one basic residue such as lysine, arginine or histidine for another, or the substitution of one acidic residue, such as aspartic acid or glutamic acid for another. Each possibility represents a separate embodiment of the present invention.

In some embodiments, the recombinant proteins are plant-based recombinant proteins. In some embodiments, the recombinant proteins are expressed in a plant cell, plant cell line, plant tissue, or any combination thereof. In some embodiments, the recombinant proteins are extracted or isolated from a plant cell, plant cell line, plant tissue, or any combination thereof. In some embodiments the plant-based recombinant proteins comprise the plant-based proteins of the disclosure. In some embodiments, the plant-based proteins comprise α Casein (αS1, αS2), β Casein, and κ Casein. In some embodiments of the disclosure, the compositions, dry dairy substitute compositions, and plurality of micelles described here comprise plant-based protein extracts, homogenates, exudates, isolates, any fraction thereof, or any combination thereof. In some embodiments, the plant-based protein extracts are plant-based lysates. In some embodiments of the disclosure, the extracts of the plant-based proteins comprise the plant-derived materials described here.

In some embodiments, the plant is a leafy green. In some embodiments, the plant is lettuce. In some embodiments, a leafy green is or comprises lettuce. In some embodiments, the plant is a cereal. In some embodiments, the plant is a cereal grain. In some embodiments, the plant is Avena sativa. In some embodiments, the plant is Lactuca sativa. In some embodiments, the plant is a leafy green, lettuce, or both.

In some embodiments, a plant derived material comprises any material produced by, secreted from, or both, a plant, or a tissue or cell thereof. In some embodiments, a plant derived material comprises a fraction, portion, or both, of the plant material. In some embodiments, the plant derived material comprises an extract, a homogenate, exudate, isolate, any fraction thereof, or any combination thereof, being derived from a plant.

In some embodiments, the composition further comprises calcium ions.

In some embodiments, calcium ions are in the form of or comprise calcium chloride (CaCl₂). In some embodiments, calcium ions are present in the composition of the invention in the form of CaCl₂.

In some embodiments, the composition comprises calcium ions in a concentration ranging from 0 mM to 1000 mM, 10 mM to 100 mM, 20 mM to 100 mM, 30 mM to 100 mM, 40 mM to 100 mM, 60 mM to 100 mM, 5 mM to 100 mM, 10 mM to 90 mM, 15 mM to 90 mM, 20 mM to 90 mM, 25 mM to 90 mM, 30 mM to 90 mM, 10 mM to 90 mM, or 40 mM to 90 mM. Each possibility represents a separate embodiment of the invention.

In some embodiments, the composition further comprises phosphate ions, polyphosphate ions, or a combination thereof.

In some embodiments, the composition further comprises at least one ion selected from: Zn²⁺, Mg²⁺, Cu²⁺, Na⁺, K⁺, Fe²⁺, Fe³⁺, or any combination thereof.

In some embodiments, the composition comprises a plurality of micelles.

As used herein, the term “plurality” encompasses any integer being equal to or greater than 2.

In some embodiments, a composition comprising a plurality of micelles as disclosed herein (when diluted at, for example, 1%-5%) is characterized by an average Zeta potential ranging between −30 and 30 mV, −25 and 30 mV, −20 and 20 mV, −17 and 10 mV, −10 and 10 mV, −15 and 10 mV, −14 and 5 mV, −13 and 1 mV, −20 and 0 mV, −11 and 20 mV, −20 and −12 mV, −20 and −13 mV, −20 and −15 mV, −18 and −12 mV, −17 and −13 mV, −16 and −11 mV, −17 mV and −6 mV, −17 mV and −10 mV, −15 mV and −10 mV, −14 mV and −8 mV, −15 and −12 mV, or −14 and −12 mV. Each possibility represents a separate embodiment of the invention.

In some embodiments, the plurality of micelles is characterized by an average particle size ranging between about 100 nm and about 500 nm, 150 nm and about 500 nm, 200 nm and about 500 nm, 250 nm and about 500 nm, 300 nm and about 500 nm, 350 nm and about 500 nm, 400 nm and about 500 nm, 150 nm and about 400 nm, 200 nm and about 400 nm, 150 nm and about 350 nm, or 100 nm and about 300 nm. Each possibility represents a separate embodiment of the invention.

In some embodiments, the plurality of micelles is characterized by an average particle size ranging between about 100 nm and about 300 nm, and 300 nm and about 500 nm. In some embodiments, the plurality of micelles is characterized by an average particle size ranging between about 120 nm and about 290 nm, and 310 nm and about 500 nm. In some embodiments, the plurality of micelles is characterized by an average particle size ranging between about 100 nm and about 250 nm, and 300 nm and about 500 nm.

In some embodiments, the plurality of micelles is characterized by at least two sub-populations of micelles. In some embodiments, the at least two sub-populations of the plurality of micelles are distinct from another based on or by average particle size.

In some embodiments, a first sub-population of the at least two sub-populations of the plurality of micelles is characterized by an average particle size ranging between 100 nm and 300 nm, 110 nm and 290 nm, 120 nm and 280 nm, 100 nm and 200 nm, 100 nm and 270 nm, or 100 nm and 250 nm. Each possibility represents a separate embodiment of the invention.

In some embodiments, a second sub-population of the at least two sub-populations of the plurality of micelles is characterized by an average particle size ranging between 300 nm and 500 nm, 310 nm and 490 nm, 320 nm and 500 nm, 330 nm and 500 nm, 350 nm and 500 nm, or 400 nm and 500 nm. Each possibility represents a separate embodiment of the invention.

In some embodiments, the plurality of micelles comprising at least two sub-populations as disclosed herein, is characterized by sterility, reduced rate or tendency to spoil, e.g., due to microorganism infection, infestation, proliferation, or the like, compared to control micelles. In some embodiments, control micelles are devoid of at least two sub-populations of a plurality of micelles.

In some embodiments, the average particle size is determined by dynamic light scattering (DLS).

As used herein, the terms “micelle” and “particle” are interchangeable.

In some embodiments, the micelle of the composition of the invention is essentially similar to a micelle of milk. In some embodiments, milk comprises or consists of bovine milk. In some embodiments, the micelle of the composition of the invention is essentially similar to a micelle of milk, optionally wherein milk is or comprises bovine milk.

As used herein, the term “essentially similar” refers to being at least 70%, 80%, 90%, 95%, or 99% identical, or any value and range therebetween. Each possibility represents a separate embodiment of the invention.

In some embodiments, essentially similar refers to the micelle of the composition of the invention having a size, average size, or maximal size, diameter, average diameter, or maximal diameter, taste, flavor, scent, organoleptic properties, or any combination thereof, essentially similar to a micelle of milk.

In some embodiments, the composition further comprises an organic acid. Types of organic acids would be apparent to one of ordinary skill in the art. Non-limiting examples of organic acids include, but are not limited to, acetic acid, lactic acid, citric acid, maleic acid, or any combination thereof.

In some embodiments, the composition is an edible composition. In some embodiments, the composition is a dairy substitute. In some embodiments, the composition is a pre dairy substitute composition/product/ingredient, e.g., being used as an ingredient and/or starting materials for the preparation of a dairy substitute.

In some embodiments, the composition is a dry composition. In some embodiments, the composition is dried. In some embodiments, the composition is lyophilized or a lyophilized composition. In some embodiments, the composition is spray dried or a spray dried composition. In some embodiments, the dried composition of the disclosure comprises a moisture content of 20% or less (e.g., 19, 17, 15, 13, 11, 9, 7, 5, 4.9, 4.7, 4.5, 4.3, 4.1, 3.9, 3.7, 3.5, 3.3, 3.1, 2.9, 2.7, 2.5, 2.3, 2.1, 1.9, 1.7, 1.5, 1.3, 1.1, 0.9, 0.7, 0.5, 0.3, 0.1); 0.2% or more (e.g., 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 8, 10, 12, 14, 16, 18, 20, 22, 24); 0.005%-20% (e.g., 0.01%-19%; 0.05%-18%; 0.1%-17%; 1%-16%; 2%-15%; 3%-14%; 4%-13%; 5%-12%; 6%-11%; 7%-10%), or a moisture content in the dried composition acceptable to ensure stability over extended periods of time and avoid microbial growth. In some embodiments, any means and methods of drying known to a person of skill in the art is contemplated by the current invention.

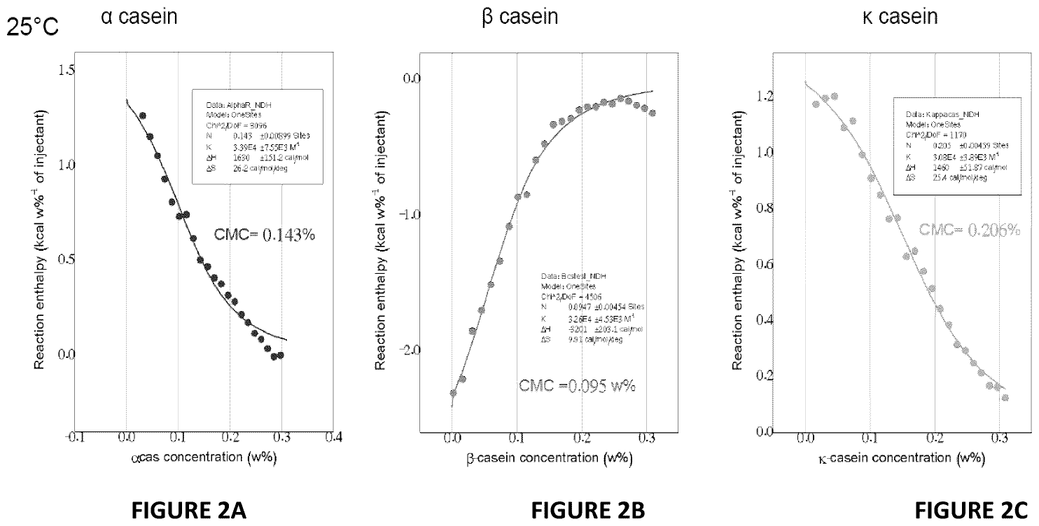

In some embodiments, the composition of the disclosure comprises a dry dairy substitute composition. In another embodiment of the disclosure, the composition described here is a dry dairy substitute powder composition. Additional embodiments of the disclosure provide for a dry dairy substitute composition comprising: a plurality of micelles. Each of such plurality of micelles comprises: a plant-based protein, a plant derived material, calcium ions, and phosphate ions. Such plant-based proteins comprise α Casein, β Casein, and κ Casein. In further embodiments, the plant-based proteins present in such compositions of the disclosure comprising α Casein, β Casein, and κ Casein are in a weight per weight ratio (w/w), respectively, of 1:1:1 or greater (e.g., 1:1:2, 1:1:3, 1:1:4, 1:1:5, 1:1:6, 1:1:7, 1:1:8, 1:1:9, 1:1:10); 10:10:1 or less (e.g., 9:9:1, 8:8:1, 7:7:1, 6:6:1, 5:5:1, 4:4:1, 3:3:1, 2:2:1, 1:1:1); or 1:1:1 to 10:10:1. Additional embodiments are directed to such compositions, where the α Casein comprises αS1 Casein, αS2 Casein, or combinations of αS1 Casein and αS2 Casein. In some embodiments, the αS1 Casein and the αS2 Casein are in a weight per weight ratio (w/w) of 1:3 or greater (e.g., 2:3, 3:3, 4:3, 5:3, 2:1, 7:3, 8:3, 3:1, 10:3); 3:1 or less (e.g., 2:1, 1:1, 1:2); or 1:3 to 3:1. Further embodiments of the disclosure provide for such compositions as described here that comprise plant-based casein proteins (i.e., αS1 Casein, αS2 Casein, β Casein, κ Casein) present in such compositions in a weight per weight ratio (w/w) of 4:1:4:1 or about 4:1:4:1. Additional embodiments of the disclosure provide for such compositions, where the plant derived material comprising an extract, a homogenate, any fraction of the extract or the homogenate, or any combination of the extract, the homogenate, fraction of the extract, and fraction of the homogenate, where the plant derived material is from a plant. Non-limiting examples of plant derived material include: oat extract (e.g., Avena sativa; Avena sativa var. nuda, Avena sativa var. mutica, Avena sativa var. Saia 4), romaine lettuce extract (e.g., Lactuca sativa; Lactuca sativa var. longifolia, Noga lettuce; Lactuca sativa var. capitata), any other fast-growing plant (e.g., 30 days-120 days), and extract or homogenate of the aforementioned plant derived materials. In further embodiments of the disclosure, calcium ions of such compositions are selected from the group consisting of: CaCl₂, CaCO₃, Ca₃(PO₄)₂, CaSO₄, Ca(OH)₂, and combinations thereof. Such calcium ions are present in the composition of the disclosure in a concentration of 2 mM or greater (e.g., 4, 6, 8, 10, 20, 30, 40, 50, 60,70, 80, 90, 100, 110, 120); 100 mM or less (e.g., 95, 85, 75, 65, 55, 45, 35, 25, 15, 9, 7, 5, 3, 1); or 2 mM-100 mM (e.g., 3 mM-99 mM; 4 mM-98 mM; 5 mM-97 mM; 6 mM-96 mM; 7 mM-95 mM; 8 mM-94 mM; 9 mM-93 mM; 10 mM-92 mM; 11 mM-91 mM; 12 mM-90 mM; 13 mM-89 mM; 14 mM-88 mM; 15 mM-87 mM). In additional embodiments, phosphate ions of the described compositions are selected from the group consisting of: Ca₃(PO₄)₂, Na₃PO₄, Na₃P₃O₁₀, K₃PO₄, K₄P₂O₇, Mg₃(PO₄)₂, and combinations thereof. Such phosphate ions are present in the composition of the disclosure in a concentration of 20 mM or greater (e.g., 30, 40, 50, 60, 70, 80, 90, 100, 110, 120, 130, 140, 150, 160); 155 mM or less (e.g., 145, 135, 125, 115, 105, 95, 85, 75, 65, 55, 45, 35, 25, 15); or 20_mM-155_mM (e.g., 25 mM-150 mM; 30 mM-145 mM; 35 mM-140 mM; 40 mM-135 mM; 45 mM-130 mM; 50 mM-125 mM; 55 mM-120 mM; 60 mM-115 mM; 65 mM-110 mM; 70 mM-100 mM; 75 mM-95 mM; 80 mM-90 mM). In some embodiments, the compositions of the disclosure comprise additional ions. Such additional ions can include one or more ions selected from the group consisting of: Zn²⁺, Mg²⁺, Cu²⁺, Na⁺, K⁺, Fe²⁺, Fe³⁺, and any combination thereof. Additional elements present in dried compositions of the disclosure include but are not limited to, calcium, magnesium, sodium, phosphorus, sulfur, and any combinations thereof. In some embodiments, the dried compositions described here comprise one or more of the additional elements, wherein: calcium is in an amount of 700 mg/kg or greater (e.g., 800; 900; 1000; 1100; 1200; 1300; 1400; 1500; 1600; 1700; 1800; 1900; 2000; 3000; 4000; 5000; 6000; 7000; 8000; 9000; 10,000; 20,000; 30,000; 40,000; 50,000; 60,000; 70,000; 80,000);75,000 mg/kg or less (e.g., 65,000; 55,000; 45,000; 35,000; 25,000; 15,000; 10,500; 9500; 8500; 7500; 6500; 5500; 4500; 3500; 2500; 1500; 500); 700 mg/kg-70,000 mg/kg (e.g., 750 mg/kg-65,500; 850 mg/kg-55,500 mg/kg; 950 mg/kg-45,500 mg/kg; 1050 mg/kg-35,500 mg/kg; 1150 mg/kg-25,500 mg/kg; 1250 mg/kg-15,500 mg/kg; 1350 mg/kg-14,500 mg/kg; 1450 mg/kg-13,500 mg/kg; 1550 mg/kg-12,500 mg/kg; 1650 mg/kg-11,500 mg/kg; 1750 mg/kg-10,550 mg/kg; 1850 mg/kg-9550 mg/kg; 1950 mg/kg-8550 mg/kg; 2050 mg/kg-7550 mg/kg; 2150 mg/kg-7050 mg/kg; 2250 mg/kg-6550 mg/kg; 2350 mg/kg-5550 mg/kg; 2450 mg/kg-4550 mg/kg; 2550 mg/kg-3550 mg/kg); magnesium is in an amount of 70 mg/kg or greater (e.g., 80; 90; 100; 200; 300; 400; 500; 600; 700; 800; 900; 1000; 2000; 3000; 4000; 5000; 6000; 7000; 8000; 9000; 10,000); 7000 mg/kg or less (e.g., 6500; 5500; 4500; 3500; 2500; 1500; 1400; 1300; 1200; 1100; 1050; 955; 950; 855; 850; 755; 750; 655; 650; 555; 550; 455; 450; 355; 350; 255; 250; 155; 150; 105; 95; 85; 75; 65; 55); 70 mg/kg-7000 mg/kg (e.g., 74 mg/kg-6550 mg/kg; 84 mg/kg-5550 mg/kg; 94 mg/kg-4550 mg/kg; 104 mg/kg-3550 mg/kg; 204 mg/kg-2550 mg/kg; 304 mg/kg-1550 mg/kg; 404 mg/kg-1450 mg/kg; 505 mg/kg-1350 mg/kg; 605 mg/kg-1250 mg/kg; 705 mg/kg-1150 mg/kg; 805 mg/kg-1055 mg/kg; 905 mg/kg-955 mg/kg); sodium is in an amount of 10,000 mg/kg or greater (e.g., 20,000; 30,000; 40,000; 50,000; 60,000; 70,000; 80,000; 90,000; 100,000; 110,000; 120,000; 130,000; 140,000; 150,000; 160,000; 170,000; 180,000; 190,000; 200,000; 300,000; 400,000; 500,000; 600,000; 700,000; 800,000; 900,000; 1,000,000; 1,100,000; 1,200,000; 1,300,000; 1,400,000; 1,500,000; 1,600,000; 1,700,000; 1,800,000; 1,900,000; 2,000,000); 1,500,000 mg/kg or less (e.g., 1,450,000; 1,350,000; 1,250,000; 1,150,000; 950,000; 850,000; 750,000; 650,000; 550,000; 450,000; 350,000; 250,000; 150,000; 550,000; 450,000; 350,000; 250,000; 150,000; 95,000; 85,000; 75,000; 65,000; 55,000; 45,000; 35,000; 25,000; 15,000; 10,500; 9550; 8550); 10,000 mg/kg-1,500,000 mg/kg (e.g., 11,500 mg/kg-1,450,000 mg/kg; 12,500 mg/kg-1,350,000 mg/kg; 13,500 mg/kg-1,250,000; 14,500 mg/kg-1,150,000 mg/kg; 15,500 mg/kg-1,050,000 mg/kg; 16,500 mg/kg-950,500 mg/kg; 17,500 mg/kg-850,500 mg/kg; 18,500 mg/kg-750,500 mg/kg; 19,500 mg/kg-650,500 mg/kg; 20,500 mg/kg-550,500 mg/kg; 51,500 mg/kg-450,500 mg/kg; 52,500 mg/kg-350,500 mg/kg; 53,500 mg/kg-250,500 mg/kg; 54,500 mg/kg-150,500 mg/kg; 55,500 mg/kg-145,500 mg/kg; 56,500 mg/kg-140,500 mg/kg; 57,500 mg/kg-135,500 mg/kg; 58,500 mg/kg-130,500 mg/kg; 59,500 mg/kg-125,500 mg/kg; 60,500 mg/kg-115,500 mg/kg; 70,500 mg/kg-105,500 mg/kg; 80,500 mg/kg-100,500 mg/kg); phosphorus is in an amount of 5,000 mg/kg or more (e.g., 6000; 7000; 8000; 9000; 10,000; 20,000; 30,000; 40,000; 50,000; 60,000; 70,000; 80,000; 90,000; 100,000; 110,000; 120,000; 130,000; 140,000; 150,000; 160,000; 170,000; 180,000; 190,000; 200,000; 300,000; 400,000; 500,000; 600,000; 700,000; 800,000; 900,000; 1,000,000; 1,100,000; 1,200,000; 1,300,000; 1,400,000; 1,500,000); 1,000,000 mg/kg or less (e.g., 950,000; 850,000; 750,000; 650,000; 550,000; 450,000; 350,000; 250,000; 150,000; 550,000; 450,000; 350,000; 250,000; 150,000; 95,000; 85,000; 75,000; 65,000; 55,000; 45,000; 35,000; 25,000; 15,000; 10,500; 9550; 8550; 7550; 6550; 5550; 4550; 3550; 2550); 5,000 mg/kg-1,000,000 mg/kg (e.g., 5250 mg/kg-9,750,000 mg/kg; 5750 mg/kg-9,250,000 mg/kg; 6250 mg/kg-8,750,000 mg/kg; 6750 mg/kg-8,250,000 mg/kg; 7250 mg/kg-7,750,000 mg/kg; 7750 mg/kg-7,250,000 mg/kg; 8250 mg/kg-6,750,000 mg/kg; 8750 mg/kg-6,250,000 mg/kg; 9250 mg/kg-5,750,000 mg/kg; 9750 mg/kg-5,250,000 mg/kg; 10,250 mg/kg-4,750,000 mg/kg; 10,750 mg/kg-4,250,000 mg/kg; 11,250 mg/kg-3,750,000 mg/kg; 11,750 mg/kg-3,250,000 mg/kg; 12,250 mg/kg-2,750,000 mg/kg; 12,750 mg/kg-2,250,000 mg/kg; 13,250 mg/kg-1,750,000 mg/kg; 13,750 mg/kg-1,250,000 mg/kg; 14,250 mg/kg-975,000 mg/kg; 14,750 mg/kg-925,000 mg/kg; 15,250 mg/kg-875,000 mg/kg; 15,750 mg/kg-825,000 mg/kg; 16,250 mg/kg-775,000 mg/kg; 16,750 mg/kg-725,000 mg/kg; 17,250 mg/kg-675,000 mg/kg; 17,750 mg/kg-625,000 mg/kg; 18,250 mg/kg-575,000 mg/kg; 18,750 mg/kg-525,000 mg/kg; 19,250 mg/kg-475,000 mg/kg; 19,750 mg/kg-425,000 mg/kg; 20,250 mg/kg-375,000 mg/kg; 20,750 mg/kg-325,000 mg/kg; 21,250 mg/kg-275,000 mg/kg; 21,750 mg/kg-225,000 mg/kg; 22,250 mg/kg-175,000 mg/kg; 22,750 mg/kg-125,000 mg/kg; 23,250 mg/kg-975,000 mg/kg; 23,750 mg/kg-925,000 mg/kg; 24,250 mg/kg-875,000 mg/kg; 24,750 mg/kg-825,000 mg/kg; 25,250 mg/kg-775,000 mg/kg; 25,750 mg/kg-725,000 mg/kg; 26,250 mg/kg-675,000 mg/kg; 26,750 mg/kg-625,000 mg/kg; 27,250 mg/kg-575,000 mg/kg; 27,750 mg/kg-525,000 mg/kg; 28,250 mg/kg-475,000 mg/kg; 28,750 mg/kg-425,000 mg/kg; 29,250 mg/kg-375,000 mg/kg; 29,750 mg/kg-325,000 mg/kg; 30,250 mg/kg-275,000 mg/kg; 30,750 mg/kg-225,000 mg/kg; 31,250 mg/kg-175,000 mg/kg; 31,750 mg/kg-125,000 mg/kg; 32,250 mg/kg-117,500 mg/kg; 32,750 mg/kg-112,500 mg/kg; 33,250 mg/kg-97,500 mg/kg; 33,750 mg/kg-97,250 mg/kg; 34,250 mg/kg-87,750 mg/kg; 34,750 mg/kg-87,500 mg/kg; 35,250 mg/kg-87,250 mg/kg; 35,750 mg/kg-86,750 mg/kg; 36,250 mg/kg-86,500 mg/kg; 36,750 mg/kg-86,250 mg/kg; 37,250 mg/kg-85,750 mg/kg; 37,750 mg/kg-85,250 mg/kg; 38,250 mg/kg-84,750 mg/kg; 38,750 mg/kg-84,250 mg/kg; 39,250 mg/kg-83,750 mg/kg; 39,750 mg/kg-83,250 mg/kg; 40,250 mg/kg-82,750 mg/kg; 40,750 mg/kg-82,250 mg/kg); and sulfur, where sulfur is in an amount of 0 mg/kg or greater (e.g., 100; 200; 300; 400; 500; 600; 700; 800; 900; 1000; 2000; 3000; 4000; 5000; 6000; 7000; 8000; 9000; 10,000; 20,000; 30,000; 40,000; 50,000; 60,000; 70,000; 80,000; 90,000; 100,000; 110,000; 120,000; 130,000; 140,000; 150,000; 160,000; 170,000; 180,000; 190,000; 200,000; 300,000); 200,000 mg/kg or less (e.g., 150,000; 550,000; 450,000; 350,000; 250,000; 150,000; 95,000; 85,000; 75,000; 65,000; 55,000; 45,000; 35,000; 25,000; 15,000; 10,500; 9550; 8550; 7550; 6550; 5550; 4550; 3550; 2550; 1550; 550); 2000 mg/kg-200,000 mg/kg (e.g., 2550 mg/kg-195,500 mg/kg; 3550 mg/kg-185,500 mg/kg; 4550 mg/kg-175,500 mg/kg; 5550 mg/kg-165,500 mg/kg; 6550 mg/kg-155,500 mg/kg; 7550 mg/kg-145,500 mg/kg; 8550 mg/kg-135,500 mg/kg; 9550 mg/kg-125,500 mg/kg; 10,550 mg/kg-115,500 mg/kg; 11,550 mg/kg-105,500 mg/kg; 12,550 mg/kg-95,500 mg/kg; 13,550 mg/kg-85,500 mg/kg; 14,550 mg/kg-75,500 mg/kg; 15,550 mg/kg-65,500 mg/kg; 16,550 mg/kg-55,500 mg/kg; 17,550 mg/kg-45,500 mg/kg; 18,550 mg/kg-35,500 mg/kg; 19,550 mg/kg-25,500 mg/kg; 19,650 mg/kg-24, 500 mg/kg; 19,750 mg/kg-23,500 mg/kg; 19,850 mg/kg-22,500 mg/kg; 19,950 mg/kg-21,500 mg/kg). Further embodiments of the disclosure provide for micelles, a plurality of micelles, or micellization at a neutral pH. Such a neutral pH comprises pH 6 or greater (e.g., pH 6.2, 6.4, 6.6, 6.8, 7, 7.2, 7.4); pH 7.2 or less (e.g., 7.1, 6.9, 6.7, 6.5, 6.3, 6.1, 5.9, 5.7); or pH 6.8-pH 7.2. Such micelles or such a plurality of micelles, either alone or in any of the compositions described here, comprise a plant-based protein of α Casein, β Casein, and κ Casein, calcium ions, and phosphate ions. Additional embodiments provide for such micelles or such a plurality of micelles, either alone or in any of the compositions described here, where such micelles or such a plurality of micelles comprise a plant-based protein of α Casein, β Casein, and κ Casein, a plant-derived material, calcium ions, and phosphate ions. In some embodiments, the plant derived proteins of caseins in the composition comprise a weight per volume (w/v) of: α Casein of about 0.14% or greater (e.g., 0.141, 0.142, 0.143, 0.144, 0.145); β Casein of about 0.09% or greater (e.g., 0.091, 0.092, 0.093, 0.094, 0.095, 0.096, 0.097, 0.098, 0.099, 0.1); and κ Casein of about 0.2% or greater (e.g., 0.201, 0.202, 0.203, 0.204, 0.205, 0.206, 0.207, 0.208, 0.209, 0.21), where these casein concentrations are the minimum critical micellization concentration necessary to form micelles of the disclosure. See, e.g., FIGS. 2A-2C.

### Method of Preparation

According to another aspect, there is provided a method for preparing the composition of the invention.

According to another aspect, there is provided a method for preparing a composition comprising: (a) a micelle dispersed in an aqueous solution, wherein the micelle comprises at least one recombinant casein protein; and (b) a plant derived material.

In some embodiments, the micelle comprises the recombinant proteins of αS Casein, Casein, and κ Casein.

In some embodiments, the recombinant proteins of αS Casein, β Casein, and κ Casein are mixed in or to a final a weight per weight ratio (w/w) of between 1:1:1 to 10:10:1, 2:2:1 to 10:10:1, 3:3:1 to 10:10:1, 4:4:1 to 10:10:1, 5:5:1 to 10:10:1, 6:6:1 to 10:10:1, 7:7:1 to 10:10:1, 2:2:1 to 8:8:1, 3:3:1 to 5:5:1, 2:2:1 to 6:6:1, or 2:2:1 to 9:9:1, in the composition. Each possibility represents a separate embodiment of the invention.

In some embodiments, the mixing is so as to obtain a plurality of micelles dispersed in an aqueous solution. In some embodiments, each micelle of the plurality of micelles comprises the recombinant proteins of αS Casein, β Casein, and κ Casein.

In some embodiments, the recombinant proteins of the plurality of micelles, such as of the composition of the invention, are plant-based recombinant proteins.

In some embodiments, the mixing is in the presence of at least one ion selected from: Ca²⁺, phosphate, polyphosphate, Zn²⁺, Mg²⁺, Cu²⁺, Na⁺, K⁺, Fe²⁺, Fe³⁺, and any combination thereof.

In some embodiments, the mixing comprises mixing the recombinant proteins with calcium chloride, calcium phosphate, or both.

In some embodiments, the mixing comprises mixing under at least one condition selected from: heat, cooling, sonication, electrolysis, or any combination thereof.

In some embodiments, mixing comprises sequential mixing according to the following order: (1) the casein recombinant proteins; (2) calcium ions or salts thereof (e.g., CaCl₂, calcium phosphate, or both); and (3) plant material.

In some embodiments, mixing comprises sequential mixing according to the following order: (1) the casein recombinant proteins; (2) plant material; and (3) calcium ions or salts thereof (e.g., CaCl₂, calcium phosphate, or both).

In some embodiments, mixing comprises sequential mixing according to the following order: (1) calcium ions or salts thereof (e.g., CaCl₂, calcium phosphate, or both); (2) the casein recombinant proteins; and (3) plant material.

In some embodiments, mixing comprises sequential mixing according to the following order: (1) calcium ions or salts thereof (e.g., CaCl₂, calcium phosphate, or both); (2) plant material; and (3) the casein recombinant proteins.

In some embodiments, mixing comprises sequential mixing according to the following order: (1) plant material; (2) calcium ions or salts thereof (e.g., CaCl₂, calcium phosphate, or both); and (3) the casein recombinant proteins.

In some embodiments, mixing comprises sequential mixing according to the following order: (1) plant material; (2) the casein recombinant proteins; and (3) calcium ions or salts thereof (e.g., CaCl₂, calcium phosphate, or both).

In some embodiments, the method comprises a step preceding the mixing, comprising mixing the recombinant proteins of αS Casein, β Casein, and κ Casein, thereby obtaining a recombinant caseins mixture.

In some embodiments, mixing comprises simultaneously mixing the casein recombinant proteins; calcium ions or salts thereof (e.g., CaCl₂, calcium phosphate, or both); and plant material.

In some embodiments, the mixing is under heating conditions.

In some embodiments, the method further comprises a step comprising determining size, shape, diameter, Zeta potential, or any combination thereof, of the prepared composition or a micelle comprised therein.

In some embodiments, the determining is according to any analytic method known to a person of skill in the art. Non-limiting examples for applicable analytic methods include, but are not limited to, dynamic light scattering (DLS), electron microscopy, laser diffraction, size exclusion chromatography, gel electrophoresis, field flow fractionation, or any combination thereof, some of which are exemplified herein below.

In some embodiments, the method further comprises a step comprising drying the composition.

Means and methods for drying are common and would be apparent to one of ordinary skill in the art. Non-limiting examples for such methods of drying include, but are not limited to, lyophilization, hot air drying, contact drying, infrared drying, freeze-drying, fluidized bed drying, spray drying, or dielectric drying, to name a few.

In some embodiments, there is provided a method for preparing an edible composition, a food composition, a foodstuff, or any combination thereof, from the composition of the invention. In some embodiments, the method comprises providing the composition of the invention. In some embodiments, the edible composition, the food composition, the foodstuff, or any combination thereof, is a dairy substitute. In some embodiments, the edible composition, the food composition, the foodstuff, or any combination thereof is a pre dairy substitute composition/product/ingredient. In some embodiments, the method comprises mixing the composition of the invention with at least one additional ingredient for the preparation of an edible composition, a food composition, a foodstuff.

According to another aspect, there is provided a method for preparing a food product that requires an amount of milk micelles, comprising substituting an amount of milk micelles required for preparing the food product with an equivalent amount of the micelles of the composition of the invention.

As used herein, the term “dairy substitute” refers to a composition which is effective in replacing milk in food compositions and provides milk-like functionality. In some embodiments, providing milk-like functionality is with reduced or significantly reduced allergenicity, sensitivity (or oral sensitivity), intolerance, or any combination thereof, in a subject consuming the dairy substitute, e.g., compared to a dairy product control.

### Food Products

In some embodiments, food products comprising such compositions as described here are produced, where the food products are those that are plant-based (i.e., entirely or partially), non-animal, non-dairy, or any combination thereof, forming analog (or alternative, used interchangeably here) food products from those prepared using, for example, animal or dairy products. As described here, in some embodiments, the compositions of the disclosure for producing analog food products, comprise a dry dairy substitute composition that comprises a plurality of micelles composed of: a plant-based protein (i.e., α casein, β casein, κ casein), a plant-derived material, calcium ions, and phosphate ions. Non-limiting examples of analog food products using such compositions or such dry dairy substitute compositions of the disclosure include: feta cheese, low-moisture mozzarella cheese, and haloumi cheese.

In some embodiments, the analog food products described here are produced using the compositions, the dried dairy substitute composition, or the plurality of micelles of the disclosure comprising: a plant-based protein (i.e.., α casein, β casein, κ casein), a plant-derived material, calcium ions, and phosphate ions, as described in the various embodiments of the disclosure. These analog food products have been shown to exhibit similar or even superior qualities over the animal or dairy equivalent products, such as but not limited to, stretchability (e.g., melt strength, stretch length, stretch quality, peak force, failure strain, resistance to deformation), melting point or meltability, firmness, moisture content, shreddability, compression, texture profile analysis (TPA), wire cutting, and combinations thereof. In some embodiments, the analog food products that form cheeses using the compositions, dried dairy substitute compositions, or the plurality of plant-based micelles have a statistically significant difference in, for example, coagulation, stretchability, meltability, any other characteristics, or combinations thereof (e.g., at least 1% or greater difference) than its animal or dairy cheese counterpart. Non-limiting examples of methods for determining stretchability of melted cheese include any conventional techniques such as: the Fork method (i.e., subjective method lifting melted cheese on a scale of 1 to 10, where 1 is least stretchable and 10 is most stretchable; Fife, et al. J. Dairy Sci. 85:3539-3545, 2002), TA-426 Cheese Stretchability apparatus test (Texture Technologies Corp., Hamilton, MA), tensile strength test (see, e.g., Fife, et al. J. Dairy Sci. 85:3539-3545, 2002), instrumental vertical elongation method, 3-pronged hook probe test (see, e.g., Fife, et al. J. Dairy Sci. 85:3539-3545, 2002; Ma et al. J Dairy Sci. 95:5561-5568, 2012), ring-and-ball method (see, e.g., Hicsasmaz et al. J. Dairy Sci. 87:1993-1998, 2004), and dynamic shear rheology (DSR) (M CR-92 Anton Paar, Vernon Hills, Illinois, USA).

In some embodiments, an analog food product of the disclosure comprises feta cheese using the compositions, the dried dairy substitute compositions, or the plurality of micelles of the disclosure. The recipe for the analog feta cheese includes (i) water at a weight percent of the total food product of 65% or greater (e.g., 67%, 69%, 71%, 73%, 75%, 77%, 79%, 81%, 83%, 85); 90% or less (e.g., 88%, 86%, 84%, 82%, 80%, 78%, 76%, 74%, 72%, 70%, 68%, 66%, 64%, 62%, 60%); or 65%-90% (e.g., 66%-89%; 67%-88%; 68%-87%; 69%-86%; 70%-85%; 71%-84%; 72%-83%; 73%-82%; 74%-81%; 75%-80%; 76%-79%; 77%-78%); (ii) the composition, the dried dairy substitute, or the plurality of micelles of the disclosure at a weight percent of the total food product of 5% or greater (e.g., 7%; 9%; 11%; 13%; 15%; 17%; 19%; 21%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%); (iii) sugar (e.g., fructose, sucrose, agave nectar, honey, maple syrup, coconut sugar, stevia, aspartame, sucralose, saccharin, advantame, neotame) at a weight percent of the total food product of 0.1% or greater (e.g., 0.3%; 0.5%; 0.7%; 0.9%; 1.1%; 1.5%; 2.1%; 2.5%; 3.1%; 3.5%; 4.1%; 4.5%; 5.1%; 5.5%; 6.1%; 6.5%; 7.1%; 7.5%; 8.1%; 8.5%; 9.1%; 9.5%; 10.1%; 10.5%); 10% or less (e.g., 9%; 8%; 7%; 6%; 5%; 4%; 3%; 2%; 1%; 0.8%; 0.6%; 0.4%; 0.2%); or 0.1%-10% (e.g., 0.2%-9%; 0.3%-8%; 0.4%-7%; 0.5%-6%; 0.6%-5%; 0.7%-4%; 0.8%-3%; 0.9%-2%; 1%-1.5%); (iv) fat (e.g., oils: avocado oil, canola oil, coconut oil, corn oil, flaxseed oil, olive oil, palm oil, peanut oil, safflower oil, soybean oil, sunflower oil, walnut oil; fruits: avocado, coconut, olives; nuts/seeds: almonds, chia seeds, hazelnuts, pecans, pumpkin seeds, sesame seeds, walnuts; animal fats: butter, fish oil, ghee, lard, suet, tallow) at a weight percent of the total food product of 5% or greater (e.g., 7%, 9%, 11%, 13%, 15%, 17%, 19%, 21%; 23%; 25%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%), all of which add up to a 100% total; and additional ingredients of: (v) a blend of mesophilic cultures and thermophilic cultures (e.g., feta culture: e.g., Lactobacillus bulgaricus, Lactobacillus delbrueckii, Lactobacillus helveticus, Lactococcus cremoris; Lactococcus lactis, Streptococcus salivarius, Streptococcus thermophilus) at a weight percent of the total weight of 0.001% or greater (e.g., 0.003, 0.005, 0.007, 0.009, 0.01, 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5); 1% or less (e.g., 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.08, 0.06, 0.04, 0.02, 0.008, 0, 0.006, 0.004, 0.002); 0.001%-1% (e.g., 0.01%-0.9%, 0.02%-0.8%, 0.03%-0.7%, 0.04%-0.6%, 0.05%-0.5%, 0.06%-0.4%, 0.07%-0.3%, 0.08%-0.2%, 0.09%-0.1%); (vi) rennet (e.g., animal vegetable, microbial) at 0.001 gram per Liter (g/L) of the total food product or greater (e.g., 0.005, 0.01, 0.03, 0.05, 0.07, 0.09, 0.1, 0.3, 0.5, 0.7, 0.9, 1.1, 1.3, 1.5, 1.7, 1.9, 2.1, 2.3, 2.5, 2.7 2.9, 3.1, 3.3, 3.5); 5 gram per Liter of the total food product or less (e.g., 4.8, 4.6, 4.4, 4.2, 4, 3.8, 3.6, 3.4, 3.2, 3, 2.8, 2.6, 2.4, 2.2, 2, 1.8, 1.6, 1.4, 1.2, 1, 0.8, 0.6, 0.4, 0.2, 0.18, 0.16, 0.14, 0.12, 0.1, 0.08, 0.06, 0.04, 0.02); or 0.001 to 5 gram per Liter of the total food product (e.g., 0.008-5,0.01-4, 0.05-3, 0.1-2, 0.5-1) (108 CFU or greater (e.g., 10⁹, 10¹⁰, 10¹¹, 10¹²); 10¹³ CFU or less (e.g., 10¹², 10¹¹, 10¹⁰, 10⁹, 10⁸, 10⁷, 10⁶); or 10⁸ CFU-10¹² CFU (e.g., 10⁹ CFU-10¹¹ CFU; 10¹⁰ CFU-10¹² CFU); (vii) calcium ions (e.g., CaCl₂, CaCO₃, Ca₃(PO₄)₂, CaSO₄, Ca(OH)₂) at a weight percent of 0.01% of total weight or greater (e.g., 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5); 1% of total weight or less (e.g., 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.08, 0.06, 0.04, 0.02, 0.008, 0, 0.006); 0.009%-1% of total weight (e.g., 0.01%-0.9%, 0.02%-0.8%, 0.03%-0.7%, 0.04%-0.6%, 0.05%-0.5%, 0.06%-0.4%, 0.07%-0.3%, 0.08%-0.2%, 0.09%-0.1%).

In some embodiments, an analog food product of the disclosure comprises low moisture mozzarella cheese (e.g., having a lower water content than regular mozzarella (e.g., 40-50%; regular mozzarella can have a water content of up to 60%) using the compositions, the dried dairy substitute compositions, or the plurality of micelles of the disclosure. The recipe for the analog low moisture mozzarella cheese includes (i) water at a weight percent of the total food product of 65% or greater (e.g., 67%, 69%, 71%, 73%, 75%, 77%, 79%, 81%, 83%, 85); 90% or less (e.g., 88%, 86%, 84%, 82%, 80%, 78%, 76%, 74%, 72%, 70%, 68%, 66%, 64%, 62%, 60%); or 65%-90% (e.g., 66%-89%; 67%-88%; 68%-87%; 69%-86%; 70%-85%; 71%-84%; 72%-83%; 73%-82%; 74%-81%; 75%-80%; 76%-79%; 77%-78%); (ii) the composition, the dried dairy substitute, or the plurality of micelles of the disclosure at a weight percent of the total food product of 5% or greater (e.g., 7%; 9%; 11%; 13%; 15%; 17%; 19%; 21%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%); (iii) fat (e.g., oils: avocado oil, canola oil, coconut oil, corn oil, flaxseed oil, olive oil, palm oil, peanut oil, safflower oil, soybean oil, sunflower oil, walnut oil; fruits: avocado, coconut, olives; nuts/seeds: almonds, chia seeds, hazelnuts, pecans, pumpkin seeds, sesame seeds, walnuts; animal fats: butter, fish oil, ghee, lard, suet, tallow) at a weight percent of the total food product of 5% or greater (e.g., 7%, 9%, 11%, 13%, 15%, 17%, 19%, 21%; 23%; 25%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%); (iv) emulsifier (e.g., coconut lecithin, egg yolk lecithin, rapeseed lecithin, soy lecithin, sunflower lecithin; gums: agar agar, gum arabic, xanthan gum, polyglycerol polyricinoleate (PGPR)) at a weight percent of the total food product of 0.05% or greater (e.g., 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5, 1.7, 1.9, 2.1, 2.3, 2.5, 2.7, 2.9, 3.1, 3.3, 3.5, 3.7, 3.9, 4.1, 4.3, 4.5, 4.7, 4.9, 5.1, 5.3, 5.5, 5.7, 5.9, 6.1, 6.3, 6.5, 6.7, 6.9, 7.1, 7.5, 7.9, 8.1, 8.3, 8.7, 8.9, 9.1, 9.3, 9.5, 9.7, 9.9, 10.1, 10.3, 10.5); 10% or less (e.g., 9, 8, 7, 6, 5, 4, 3, 2, 1, 0.95, 0.85, 0.75, 0.65, 0.55, 0.45, 0.35, 0.25, 0.15, 0.05, 0.04, 0.03, 0.02, 0.01); 0.05%-10% (e.g., 0.1%-9.5%; 0.2%-9%; 0.3%-8.5%; 0.4%-8%; 0.5%-7.5%; 0.6%-7%; 0.7%-6.5%; 0.8%-6%; 0.9%-5.5%; 1%-5%; 1.1%-4.5%; 1.2%-4%; 1.3%-3.5%; 1.4%-3%; 1.5%-2.5%), all of which add up to a 100% total; and additional ingredients of: (v) acid (e.g., buttermilk, citric acid, cream of tartar, lemon juice, vinegar, yogurt) at a weight percent of the total weight of 1% or greater (e.g., 3, 5, 7, 9, 11, 13, 15, 17, 19, 21, 23, 25); 20% or less (e.g., 18, 16, 14, 12, 10, 8, 6, 4, 2); 1%-20% (e.g., 1.5%-19.5%; 2%-19%; 2.5%-18.5%; 3%-18%; 3.5%-17.5%; 4%-17%; 4.5%-16.5%; 5%-16%; 5.5%-15.5%; 6%-15%; 6.5%-14.5%; 7%-14%; 7.5%-13.5%; 8%-13%; 8.5%-12.5%; 9%-12%; 9.5%-11.5%; 10%-11%); (vi) base (e.g., sodium citrate (e.g., 1M), sodium hydroxide (e.g., 1M), sodium polyphosphate (e.g., 1M)) at a weight percent of 0.01% of total weight or greater (e.g., 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5); 5% of total weight or less (e.g., 4.5, 4, 3.5, 3, 2.5, 2, 1, 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.08, 0.06, 0.04, 0.02, 0.008, 0.006); 0.009%-5% of total weight (e.g., 0.01%-4.75%; 0.02%-4.5%, 0.03%-4.25%, 0.04%-4%, 0.05%-3.75%, 0.06%-3.5%, 0.07%-3.25%, 0.08%-3%, 0.09%-2.75%; 0.1%-2.5%; 0.2%-2.25%; 0.3%-2%; 0.4%-1.75%; 0.5%-1.5%; 0.6%-1.25%; 0.7%-1%).

In some embodiments, an analog food product of the disclosure comprises haloumi cheese using the compositions, the dried dairy substitute compositions, or the plurality of micelles of the disclosure. The recipe for the analog haloumi cheese includes (i) water at a weight percent of the total food product of 65% or greater (e.g., 67%, 69%, 71%, 73%, 75%, 77%, 79%, 81%, 83%, 85); 90% or less (e.g., 88%, 86%, 84%, 82%, 80%, 78%, 76%, 74%, 72%, 70%, 68%, 66%, 64%, 62%, 60%); or 65%-90% (e.g., 66%-89%; 67%-88%; 68%-87%; 69%-86%; 70%-85%; 71%-84%; 72%-83%; 73%-82%; 74%-81%; 75%-80%; 76%-79%; 77%-78%); (ii) the composition, the dried dairy substitute, or the plurality of micelles of the disclosure at a weight percent of the total food product of 5% or greater (e.g., 7%; 7.1%; 7.3%; 7.5%; 7.7%; 7.9; 9%; 9.1%; 9.3%; 9.5%; 9.7%; 9.9%; 11%; 11.1%; 11.3%; 11.5%; 11.7%; 11.9%; 13%; 13.1%; 13.3%; 13.5%; 13.7%; 13.9%; 15%; 15.1%; 15.3%; 15.5%; 15.7%; 15.9%; 17%; 17.1%; 17.3%; 17.5%; 17.7%; 17.9%; 19%; 19.1%; 19.3%; 19.5%; 19.7%; 19.9%; 21%; 21.1%; 21.3%; 21.5%; 21.7%; 21.9%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%); (iii) fat (e.g., oils: avocado oil, canola oil, coconut oil, corn oil, flaxseed oil, olive oil, palm oil, peanut oil, safflower oil, soybean oil, sunflower oil, walnut oil; fruits: avocado, coconut, olives; nuts/seeds: almonds, chia seeds, hazelnuts, pecans, pumpkin seeds, sesame seeds, walnuts; animal fats: butter, fish oil, ghee, lard, suet, tallow) at a weight percent of the total food product of 5% or greater (e.g., 7%, 9%, 11%, 13%, 15%, 17%, 19%, 21%; 23%; 25%); 20% or less (e.g., 18%; 16%; 14%; 12%; 10%; 8%; 6%; 4%; 2%); or 5%-20% (e.g., 6%-19%; 7%-18%; 8%-17%; 9%-16%; 10%-15%; 11%-14%; 12%-13%); (iv) sugar (e.g., fructose, sucrose, agave nectar, honey, maple syrup, coconut sugar, stevia, aspartame, sucralose, saccharin, advantame, neotame) at a weight percent of the total food product of 0.1% or greater (e.g., 0.3%; 0.5%; 0.7%; 0.9%; 1.1%; 1.3%; 1.5%; 1.7%; 1.9%; 2.1%; 2.3%; 2.5%; 2.7%; 2.9%; 3.1%; 3.3%; 3.5%; 3.7%; 3.9%; 4.1%; 4.3%; 4.5%; 4.7%; 4.9%; 5.1%; 5.3%; 5.5%; 5.7%; 5.9%; 6.1%; 6.3%; 6.5%; 6.7%; 6.9%; 7.1%; 7.3%; 7.5%; 7.7%; 7.9%; 8.1%; 8.3%; 8.5%; 8.7%; 8.9%; 9.1%; 9.3%; 9.5%; 9.7%; 9.9%; 10.1%; 10.3%; 10.5%; 10.7%; 10.9%); 10% or less (e.g., 9%; 8.8%; 8.6%; 8.4%; 8.2%; 8%; 7.8%; 7.6%; 7.4%; 7.2%; 7%; 6.8%; 6.6%; 6.4%; 6.2%; 6%; 5.8%; 5.6%; 5.4%; 5.2%; 5%; 4.8%; 4.6%; 4.4%; 4.2%; 4%; 3.8%; 3.6%; 3.4%; 3.2%; 3%; 2%; 1%; 0.8%; 0.6%; 0.4%; 0.2%); or 0.1%-10% (e.g., 0.2%-9%; 0.3%-8%; 0.4%-7%; 0.5%-6%; 0.6%-5%; 0.7%-4%; 0.8%-3%; 0.9%-2%; 1%-1.5%), all of which add up to a 100% total; and additional ingredients of: (v) rennet (e.g., animal vegetable, microbial) at 0.001 gram per Liter (g/L) of the total food product or greater (e.g., 0.005, 0.01, 0.03, 0.05, 0.07, 0.09, 0.1, 0.3, 0.5, 0.7, 0.9, 1.1, 1.3, 1.5, 1.7, 1.9, 2.1, 2.3, 2.5, 2.7, 2.9, 3.1, 3.3, 3.5); 5 gram per Liter of the total food product or less (e.g., 4.8, 4.6, 4.4, 4.2, 4, 3.8, 3.6, 3.4, 3.2, 3, 2.8, 2.6, 2.4, 2.2, 2, 1.8, 1.6, 1.4, 1.2, 1, 0.8, 0.6, 0.4, 0.2, 0.18, 0.16, 0.14, 0.12, 0.1, 0.08, 0.06, 0.04, 0.02); or 0.001 gram per Liter to 5 gram per Liter of the total food product (e.g., 0.008-5, 0.01-4, 0.05-3, 0.1-2, 0.5-1) (10⁸ CFU or greater (e.g., 10⁹, 10¹⁰, 10¹¹, 10¹²); 10¹³ CFU or less (e.g., 10¹², 10¹¹, 10¹⁰, 10⁹, 10⁸, 10⁷, 10⁶); or 10⁸ CFU-10¹² CFU (e.g., 10⁹ CFU-10¹¹ CFU; 10¹⁰ CFU-10¹² CFU); (vi) mesophilic cultures (e.g., Lactobacillus casein, Lactobacillus helveticus, Lactococcus lactis, MA Nov. 14, 2016-19, MA 4001-4002, M M 100-101, BT 02) at a weight percent of the total weight of 0.001% or greater (e.g., 0.003, 0.005, 0.007, 0.009, 0.01, 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5); 1% or less (e.g., 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.08, 0.06, 0.04, 0.02, 0.008, 0, 0.006, 0.004, 0.002); 0.001%-1% (e.g., 0.01%-0.9%, 0.02%-0.8%, 0.03%-0.7%, 0.04%-0.6%, 0.05%-0.5%, 0.06%-0.4%, 0.07%-0.3%, 0.08%-0.2%, 0.09%-0.1%); (vii) calcium ions (e.g., CaCl₂, CaCO₃, Ca₃(PO₄)₂, CaSO₄, Ca(OH)₂ 10%-50%) at a weight percent of 0.01% of total weight or greater (e.g., 0.03, 0.05, 0.07, 0.09, 0.11, 0.13, 0.15, 0.17, 0.19, 0.21, 0.23, 0.25, 0.27, 0.29, 0.31, 0.33, 0.35, 0.37, 0.39, 0.41, 0.43, 0.45, 0.47, 0.49, 0.51, 0.53, 0.55, 0.57, 0.59, 0.61, 0.63, 0.65, 0.67, 0.69, 0.71, 0.73, 0.75, 0.77, 0.79, 0.81, 0.83, 0.85, 0.87, 0.89, 0.91, 0.93, 0.95, 0.97, 0.99, 1.1, 1.3, 1.5); 1% of total weight or less (e.g., 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.08, 0.06, 0.04, 0.02, 0.008, 0, 0.006); 0.009%-1% of total weight (e.g., 0.01%-0.9%, 0.02%-0.8%, 0.03%-0.7%, 0.04%-0.6%, 0.05%-0.5%, 0.06%-0.4%, 0.07%-0.3%, 0.08%-0.2%, 0.09%-0.1%).

Exemplary recipes of such analog food products of the disclosure are presented in the following tables:

ANALOG FETA CHEESE

| | Weight |
|---|---|
| | Percent of |
| | Total Food |
| INGREDIENTS | Product |
| Water | 65-90% |
| Dried Dairy Substitute of Disclosure | 5-20% |
| Sugar (e.g., fructose, sucrose, agave nectar, honey, | 0.1%-10% |
| maple syrup, coconut sugar, stevia, aspartame, | |
| sucralose, saccharin, advantame, neotame) | |
| Fat (e.g., oils: avocado oil, canola oil, coconut oil, | 5-20% |
| corn oil, flaxseed oil, olive oil, palm oil, peanut oil, | |
| safflower oil, soybean oil, sunflower oil, walnut | |
| oil; fruits: avocado, coconut, olives; nuts/seeds: | |
| almonds, chia seeds, hazelnuts, pecans, pumpkin | |
| seeds, sesame seeds, walnuts; animal fats: butter, | |
| fish oil, ghee, lard, suet, tallow) | |
| Total | 100% |

Additional Ingredients

| | |
|---|---|
| Blend of mesophilic cultures and thermophilic | 0.001%-1% |
| cultures (e.g., Feta culture: e.g., Lactobacillus | |
| bulgaricus, Lactobacillus delbrueckii, | |
| Lactobacillus helveticus, Lactococcus cremoris; | |
| Lactococcus lactis, Streptococcus salivarius, | |
| Streptococcus thermophilus) | |
| Rennet (e.g., animal, vegetable, microbial) | 0.001 g/L-5 g/L |
| | (10⁸ CFU-10¹² |
| | CFU) |
| Calcium ions (e.g., CaCl₂, CaCO₃, Ca₃(PO₄)₂, | 0.009 wt %-2 wt % |
| CaSO₄, Ca(OH)₂) | |

ANALOG LOW-MOISTURE MOZZARELLA CHEESE

| | Weight Percent |
|---|---|
| | of Total Food |
| INGREDIENTS | Product |
| Water | 65%-90% |
| Dried Dairy Substitute of Disclosure | 5%-20% |
| Fat (e.g., oils: avocado oil, canola oil, coconut oil, | 5%-20% |
| corn oil, flaxseed oil, olive oil, palm oil, peanut oil, | |
| safflower oil, soybean oil, sunflower oil, walnut oil; | |
| fruits: avocado, coconut, olives; nuts/seeds: almonds, | |
| chia seeds, hazelnuts, pecans, pumpkin seeds, | |
| sesame seeds, walnuts; animal fats: butter, fish oil, | |
| ghee, lard, suet, tallow) | |
| Emulsifiers (e.g., coconut lecithin, egg yolk lecithin, | 0.05%-10% |
| rapeseed lecithin, soy lecithin, sunflower lecithin; | |
| gums: agar agar, gum arabic, xanthan gum, | |
| polyglycerol polyricinoleate (PGPR)) | |
| Total | 100% |

Additional Ingredients

| | |
|---|---|
| Acid (e.g., buttermilk, citric acid, cream of tartar, | 1%-20% |
| lemon juice, vinegar, yogurt) (1%-10%) | |
| Base (e.g., sodium citrate, sodium hydroxide, | 0.01%-5% |
| sodium polyphosphate) (0.01M-2M) | |

ANALOG HALOUMI CHEESE

| | Weight Percent |
|---|---|
| | of Total Food |
| INGREDIENTS | Product |
| Water | 65%-90% |
| Dried Dairy Substitute of Disclosure | 5%-20% |
| Fat (e.g., oils: avocado oil, canola oil, coconut oil, | 5%-20% |
| corn oil, flaxseed oil, olive oil, palm oil, peanut oil, | |
| safflower oil, soybean oil, sunflower oil, walnut oil; | |
| fruits: avocado, coconut, olives; nuts/seeds: almonds, | |
| chia seeds, hazelnuts, pecans, pumpkin seeds, | |
| sesame seeds, walnuts; animal fats: butter, fish oil, | |
| ghee, lard, suet, tallow) | |
| Sugar (e.g., advantame, agave nectar, aspartame, | 0.1%-10% |
| coconut sugar, fructose, honey, maple syrup, | |
| neotame, saccharin, stevia, sucralose, sucrose) | |
| Total | 100% |

Additional Ingredients

| | |
|---|---|
| Rennet (e.g., animal, vegetable, microbial) | 0.001 g/L-5 g/L |
| | 10⁸ CFU-10¹² |
| | CFU |
| Mesophilic cultures (e.g., Lactobacillus casei, | 0.001%-1% |
| Lactobacillus helveticus, Lactococcus lactis, | |
| MA11-14-16-19, MA 4001-4002, | |
| MM100-101, BT 02) | |
| Calcium ions (e.g., CaCl₂, CaCO₃, Ca₃(PO₄)₂, | 0.01%-1% |
| CaSO₄, Ca(OH)₂) (10%-50%) | |

Non-limiting examples of analog food products using the described compositions of the disclosure comprising a dried dairy substitute or plurality of micelles as described here include: milk, cream, half-and −half, yogurt, sour cream, ice cream, butter, margarine, cheese, pudding, chocolate, cereal bars, cheese-flavored chips or crackers, cream-based soups, custards, or any other food product that typically uses cow's milk or cow's milk products thereof.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

The descriptions of the various embodiments of the present invention have been presented for purposes of illustration but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various embodiments and aspects of the present invention as delineated hereinabove and as claimed in the claims section below find experimental support in the following examples.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein, and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds.) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, CT (1994); Mishell and Shiigi (eds), “Strategies for Protein Purification and Characterization-A Laboratory Course Manual” CSHL Press (1996); all of which are incorporated by reference. Other general references are provided throughout this document.

### Materials

Twenty (20) mg/ml in PBS solution of each casein (Sigma).

Romaine (Lactuca sativa var. longifolia) solution in PBS or Citrate-Phosphate buffer.

Oat (Avena sativa) solution in PBS or Citrate-Phosphate buffer.

Genetically modified Romaine lettuce powdered extract, in which the lettuce expresses recombinant bovine caseins.

Calcium phosphate saturated solution.

Calcium chloride.

Magnesium chloride.

0.1M Citric acid solution.

0.2M Dibasic sodium phosphate.

Nile red (1 mg/ml).

### Methods

### Isothermal Titration Calorimetry (ITC)

ITC was used to directly measure the heat discharged or consumed all along a bimolecular reaction. Using ITC measures the inventors obtained the presented data regarding: (a) Heat flow; and (b) Reaction enthalpy (ΔH).

### Dynamic Light Scattering (DLS)

Using DLS, the inventors analyzed aggregates in macromolecules to determine the size of proteins. The scattered light is used to determine the diffusion coefficient and the particle size by the Stokes-Einstein equation. DLS was utilized to obtain information about: (a) Zeta potential; (b) Intensity; (c) Volume; and (d) Count of particles.

### Micelles Construction

Stepwise construction of casein micelles was accomplished by combining α and β caseins in a solution, prior to the addition of κ casein.

Assembly of all four caseins into micelles was performed by a heat treatment with the addition of food grade salts. Half (0.5) a gr of standard casein mixture (Sigma) were added to 10 ml double-distilled water (DDW) or 10 ml plant extract, or 10 ml of genetically modified plants extract heated in a water bath to 50° C. Casein mixture was allowed to heat and swell during constant stirring. pH was adjusted to 6.5-7.1 and the solution was further heated to 70° C. When casein was completely dissolved, the solution was set to cool and food grade salts and CaCl2 were added. pH was once again adjusted, and the obtained “milk” was pasteurized in an autoclave.

### Nile Red (NR) Staining

Briefly, 25 μl of NR (1 mg/ml) were added to 1 ml from each tested sample. Samples were incubated for 15 minutes, centrifuged for 2 minutes at 2,000 rpm on a tabletop centrifuge, and measured in a 96-well plate at an excitation wavelength of 559 nm. In addition, samples were examined and imaged using fluorescent binocular following 24 hours of incubation.

### Western Blot (WB)

“Milk” samples before and after micellization were separated by 4-20% sodium dodecyl sulfate polyacrylamide gel electrophoresis (SDS-PAGE; Invitrogen), after which they were transferred to a nitrocellulose membrane (Bio-Rad). The membrane was blocked to prevent non-specific antibody binding and incubated with an anti-casein antibody (abcam), and a secondary horseradish peroxidase (HRP)-conjugated antibody.

### Direct-Imaging Cryogenic-Transmission Electron Microscopy (Cryo-TEM)

Cryo-TEM analysis performed at the Technion, Israel, using an in-house standard protocols.

### Example 1

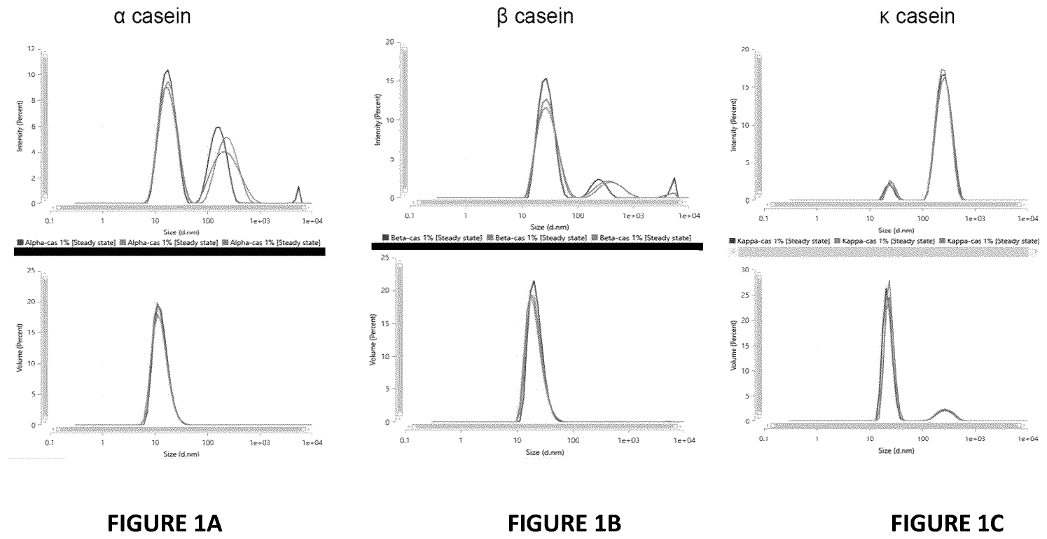

As a preliminary analysis, the inventors showed individual caseins can form micelles (FIGS. 1-2), but not in an efficient manner, as indicated by the low to absent peak of protein aggregates in the higher molecular weight size in the lower panels.

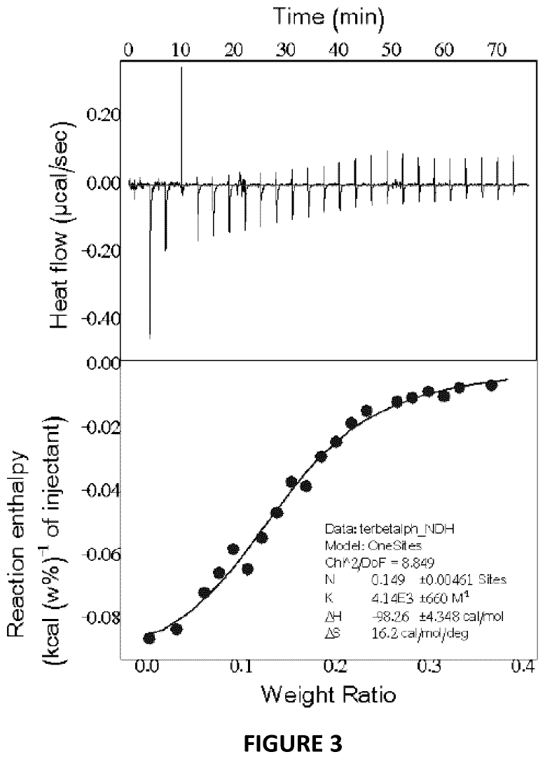

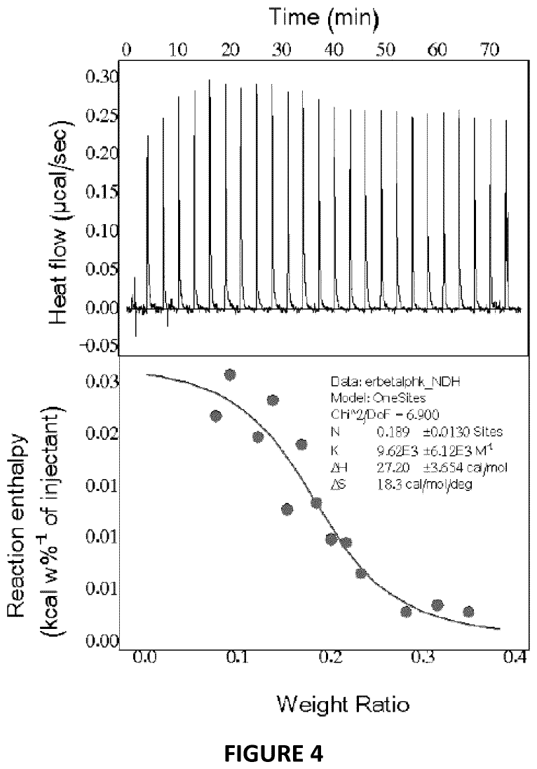

To form “milk-like” micelles, multiple caseins are required to properly interact. Therefore, the inventors have titrated α casein into a solution comprising β casein. According to an ITC study, the inventors showed that protein interaction occurred between the α and β caseins, as was reflected by a sigmoidal increase of the reaction's enthalpy (FIG. 3). Further, the inventors have examined the ability of α, β, and κ caseins to assemble micelles. The results show that a sigmoidal decrease in reaction's enthalpy was observed over time, which is indicative of κ casein interaction with the α and β caseins (FIG. 4).

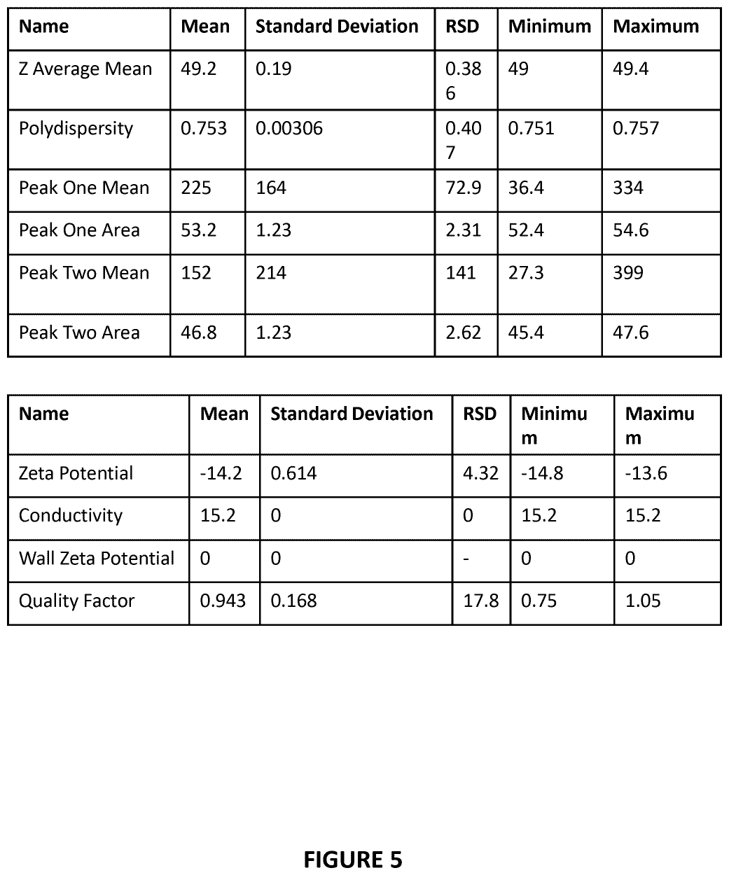

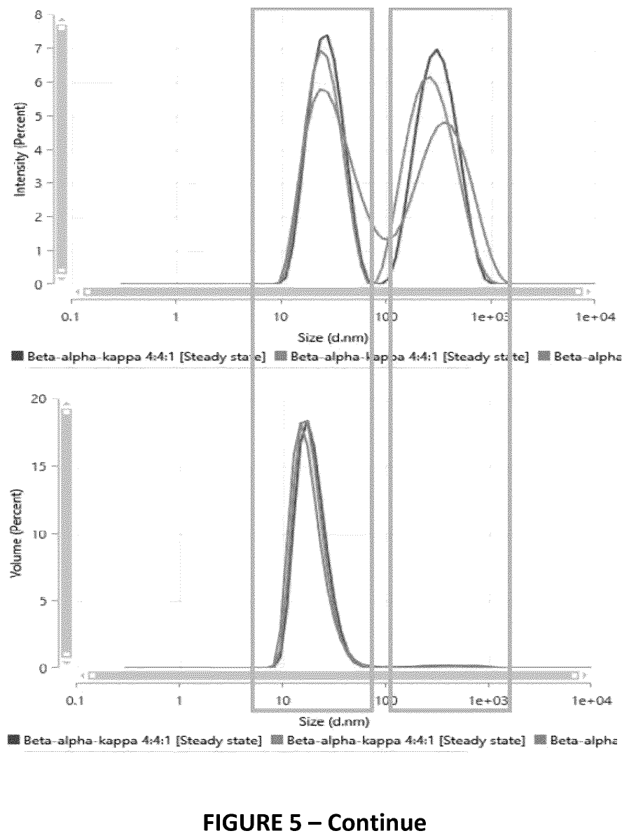

The inventors have further examined the assembly of all four caseins, αS1 Casein, αS2 Casein, β Casein, and κ Casein, into micelles, in the absence of any additive, e.g., salts or ions, in a DLS study. The results show that indeed particles in a desired micellar size were obtained (FIG. 5 the left peak in the top and bottom diagrams). In that regard, the particles' volume was rather low compared to the volume of the free protein(s) (FIG. 5, bottom diagram, right square).

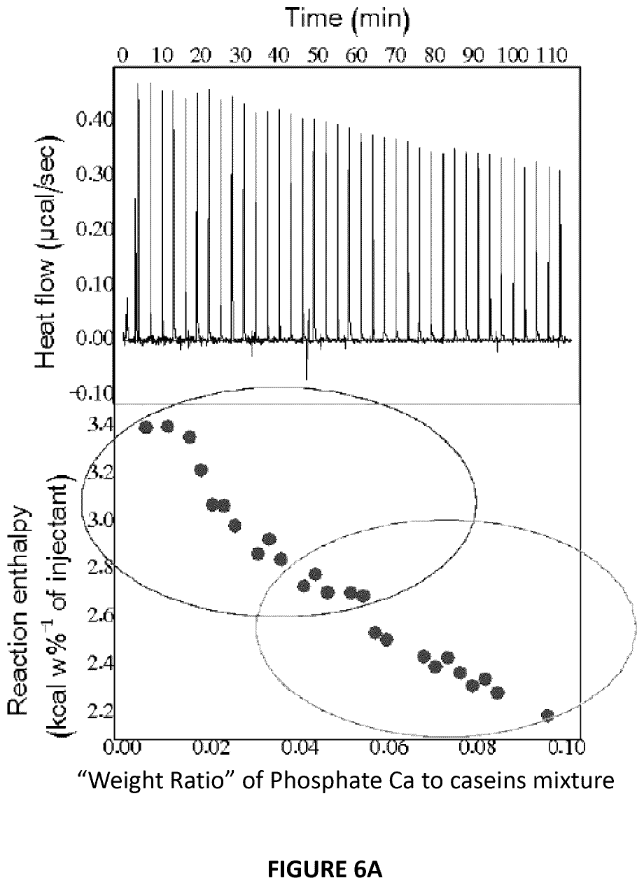

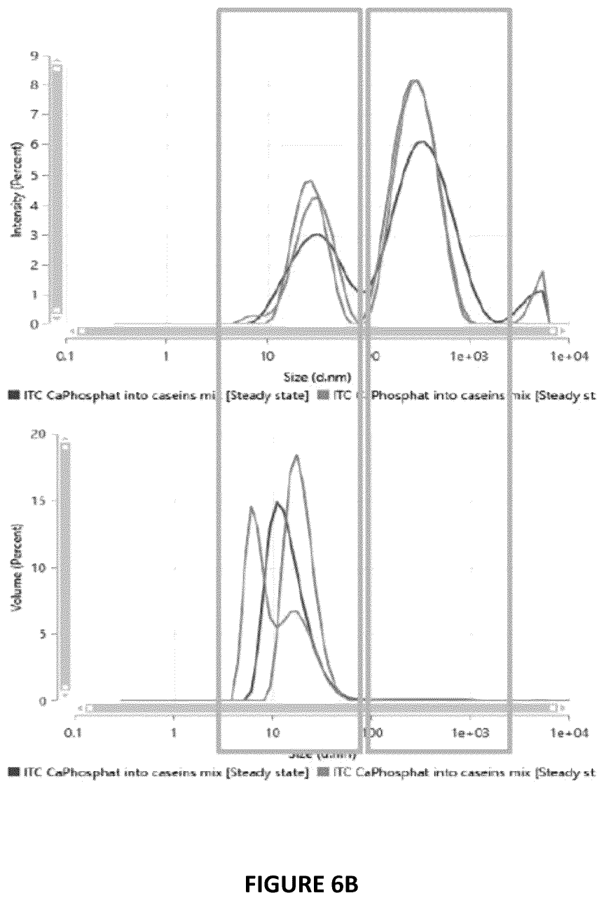

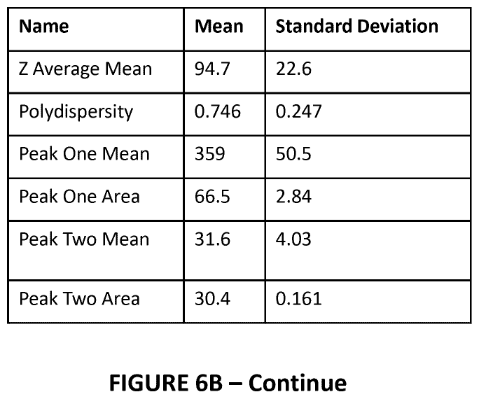

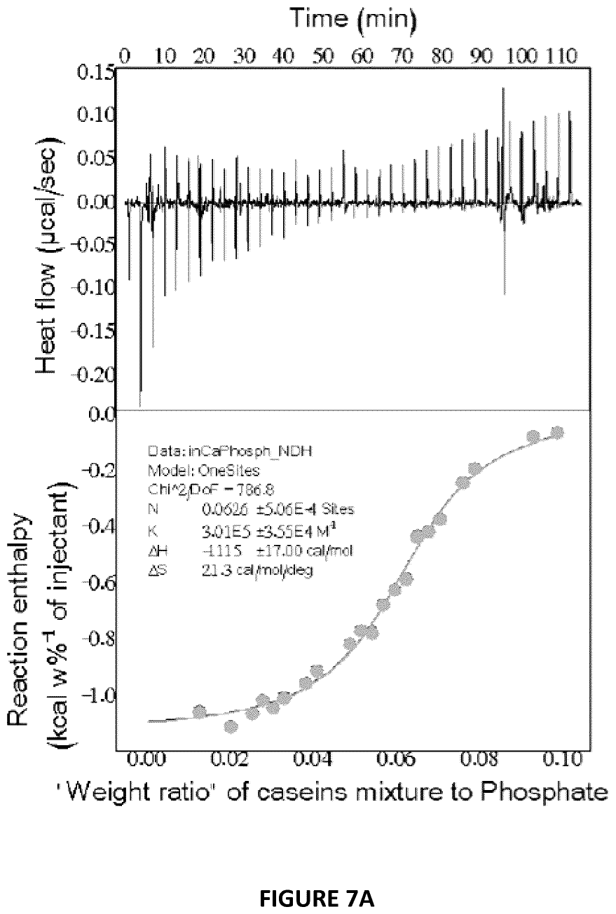

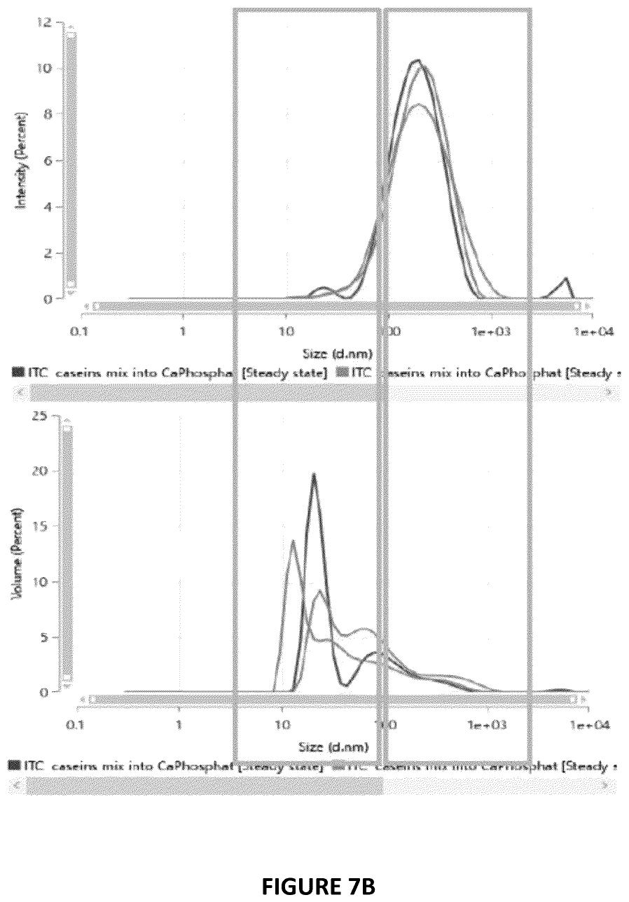

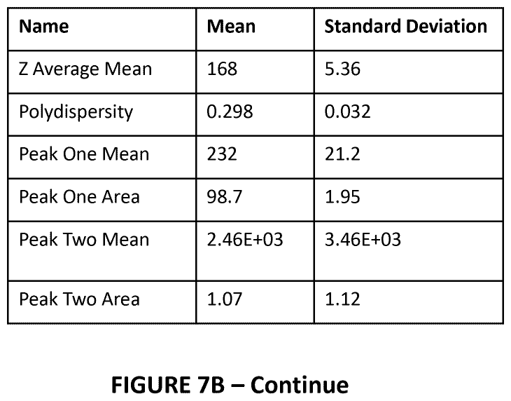

The inventors then examined the effect of salts addition on the assembly of all four caseins, αS1 Casein, αS2 Casein, β Casein, and κ Casein, into micelles. In addition, the order of addition was tested, e.g., titrating salts into the caseins mixture or vice versa. The results show that when a saturated solution of calcium phosphate was titrated into the caseins mixture, particles in the desired micellar size were observed as before (yet at lower volume compared to the volume of the free protein(s); FIG. 6). Further, the results show that when α caseins mixture was titrated into a saturated solution of calcium phosphate the equilibrium between single caseins and micellar caseins was pushed towards the micellar organization as observed in both intensity and volume, when calcium and phosphate are unrestrained (FIG. 7).

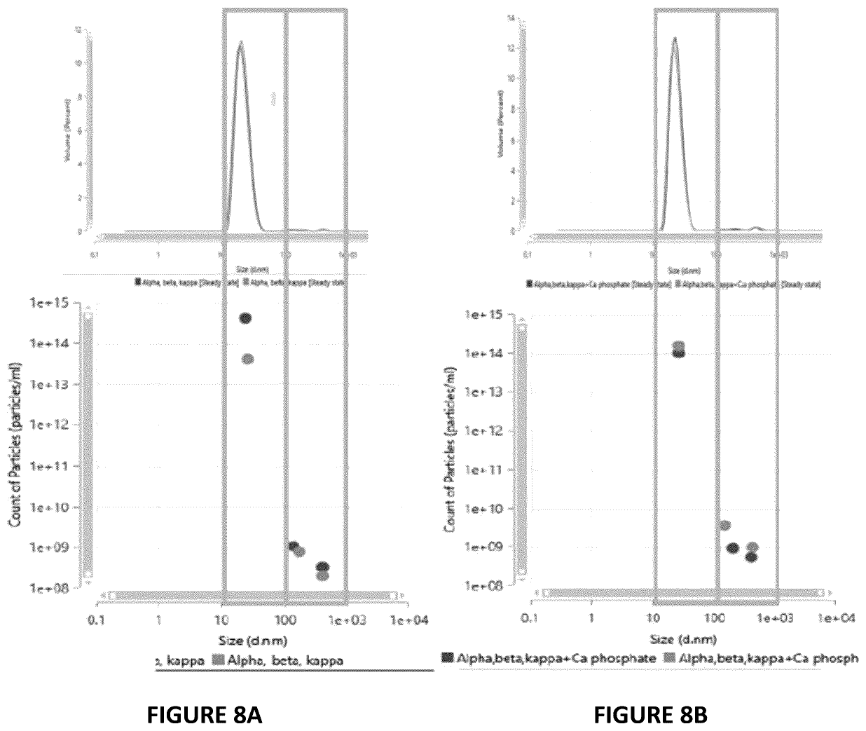

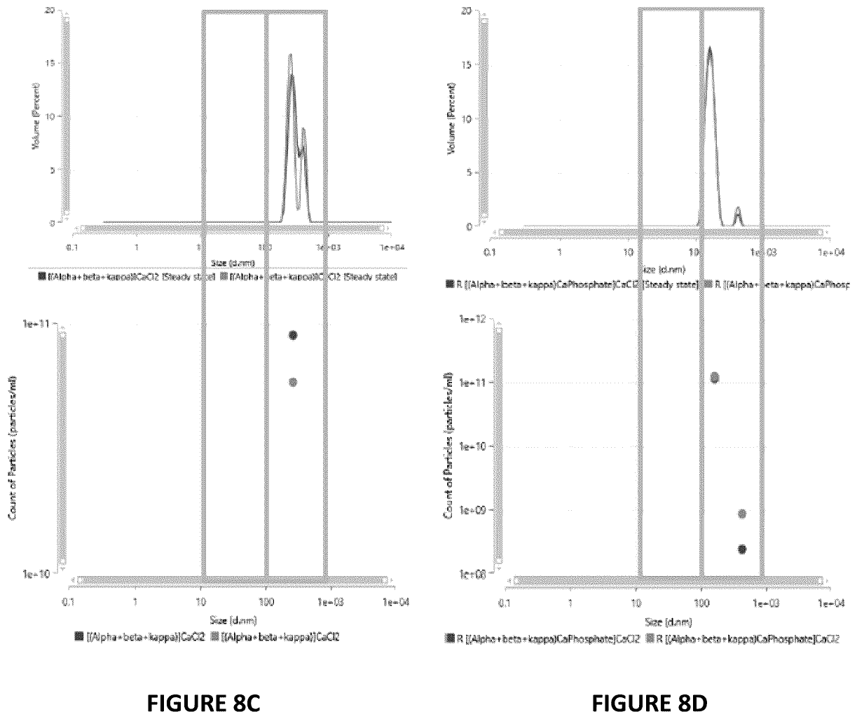

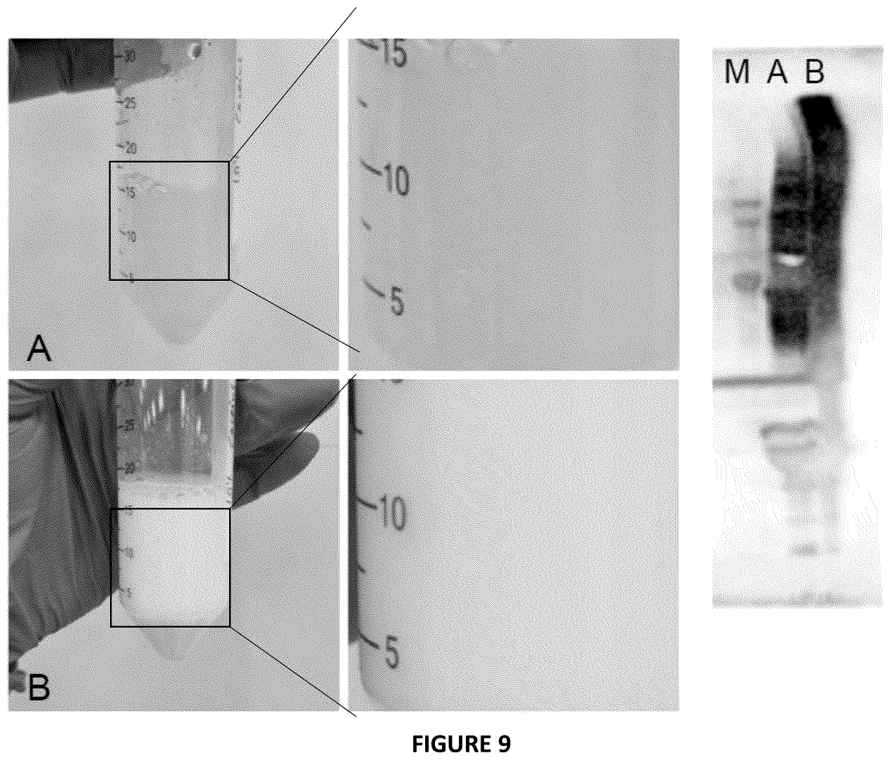

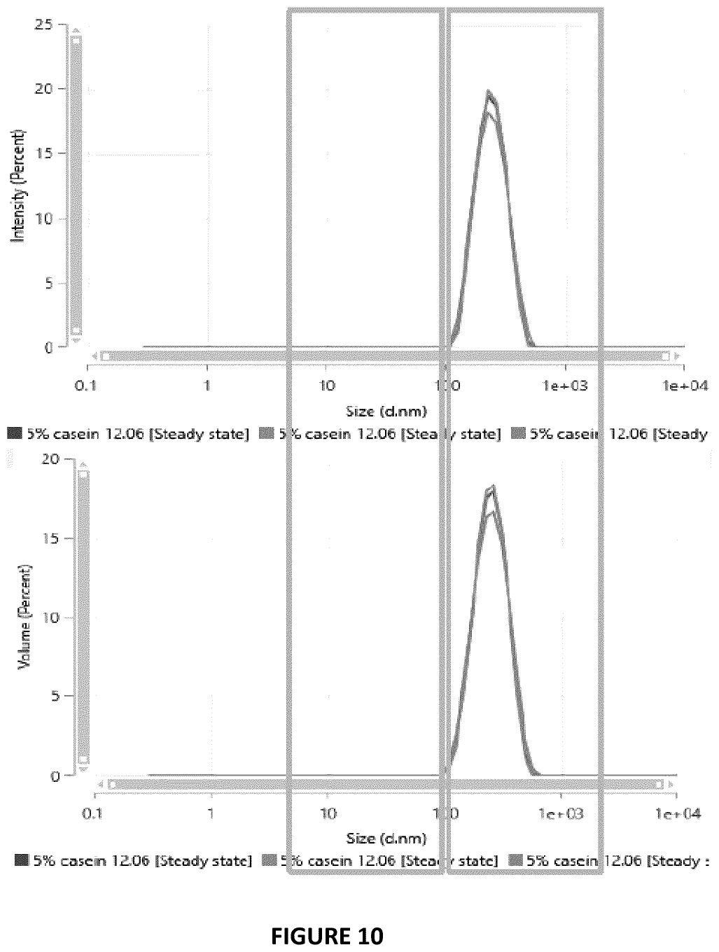

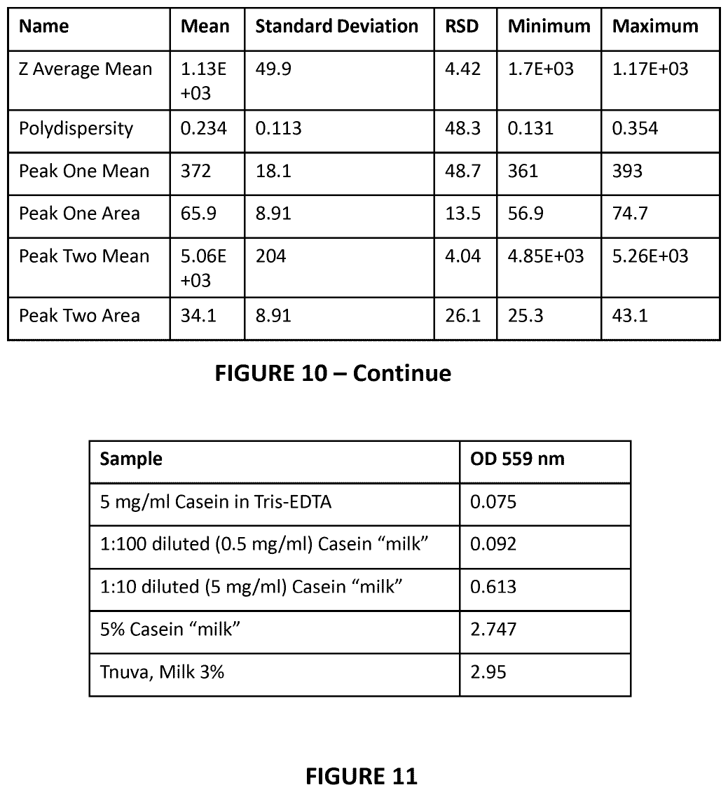

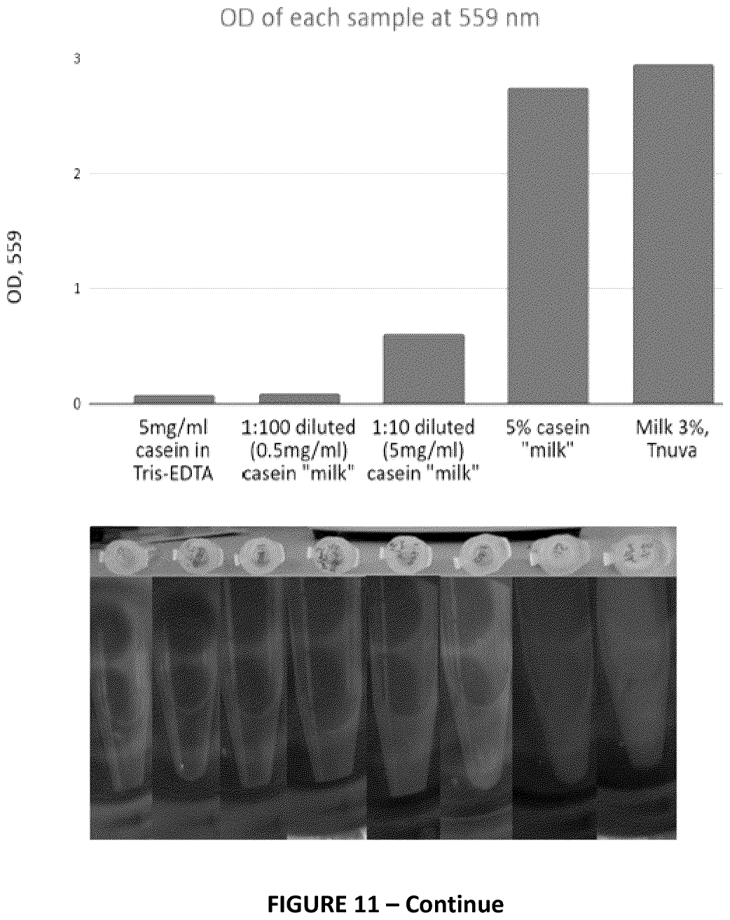

The inventors further examined different ways to add calcium ions to the caseins mixture. The inventors tested the addition of calcium phosphate, calcium chloride, and a combination of both. The results show that obtaining protein aggregates in a size equivalent to that of milk micelles, e.g., 200-250 nm on average, requires addition of different salts in a particular proportion (FIG. 8). Under heat conditions, the inventors have further shown that visible changes occur in the casein mixture following titration of salts (FIG. 9). This change in coloration was accompanied by an increase in molecular weight, as was evident by a western blot analysis (Fig, 9). According to a DLS analysis, titration of food grade salt into a mixture comprising all four caseins as described above, under heat conditions, provided particles in the desired micellar size, yet, contrary to previous attempts as described herein above, these were the major population of particles in the sample (FIG. 10). To further characterize these micelles, the inventors further used Nile red staining. The results show that the micelles disclosed herein resemble hydrophobic characteristics of commercially available bovine milk (FIG. 11).

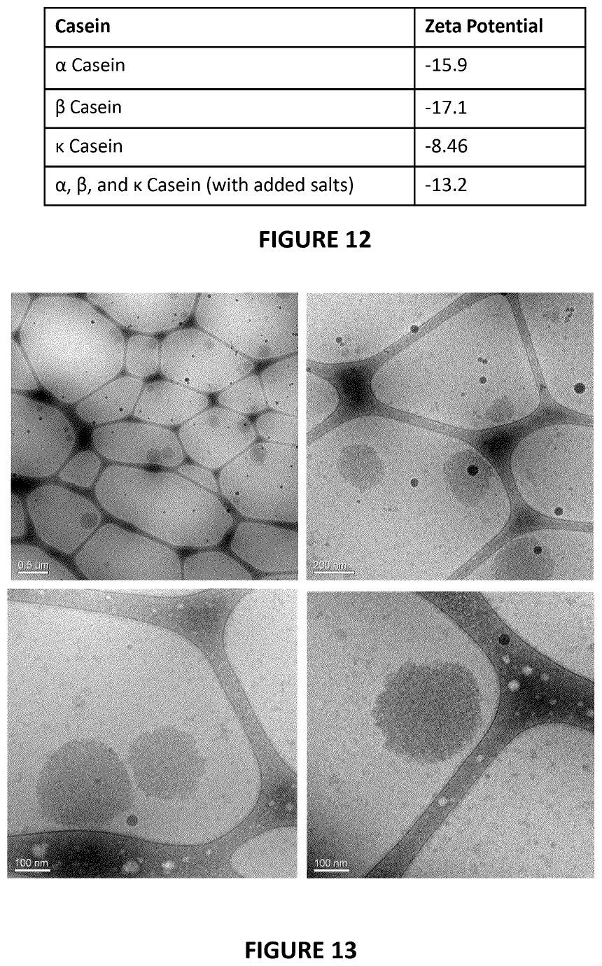

Using Zeta potential analysis, the inventors showed that the observed zeta potential of the caseins mixture is higher than any one of a and β caseins alone. The results may suggest that the κ casein, which has a highest Zeta potential among the three caseins, is located on the surface of the particles (FIG. 12). Using cryo-TEM, the inventors demonstrated in term of their average size (200-250 nm) α, β, and κ caseins with saturated calcium phosphate and 0.2% CaCl₂ form protein aggregates that equivalent to milk micelles (FIG. 13).

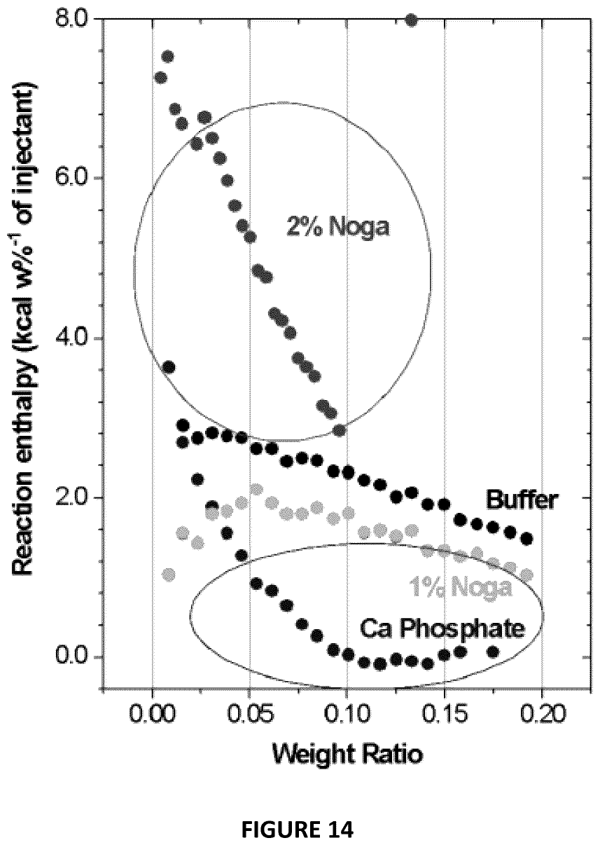

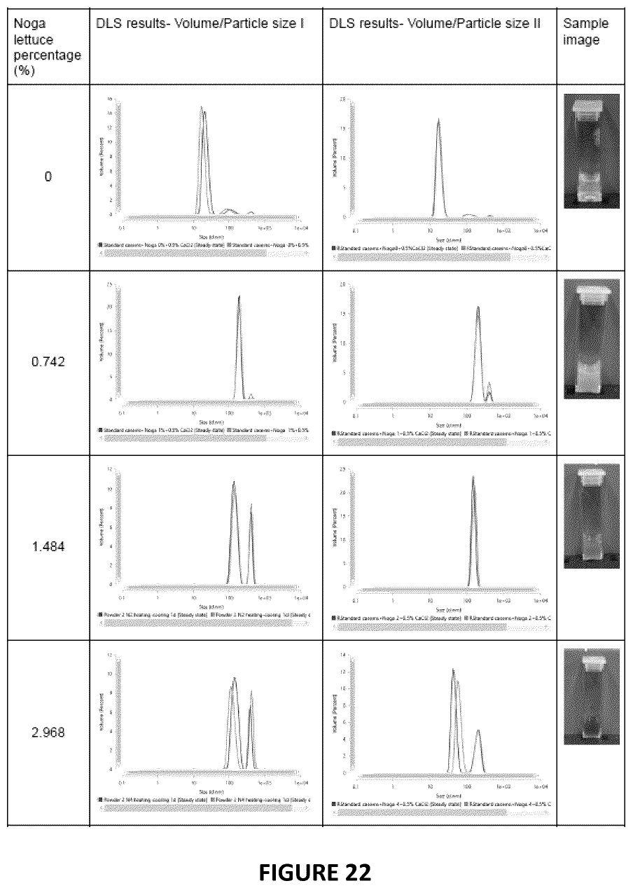

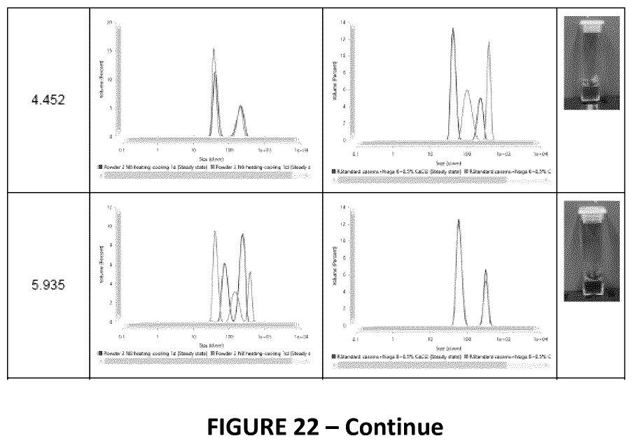

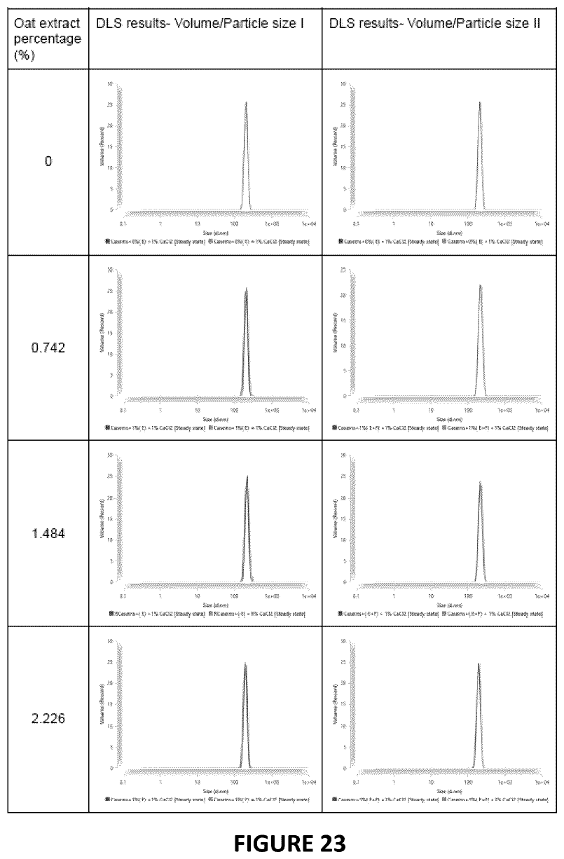

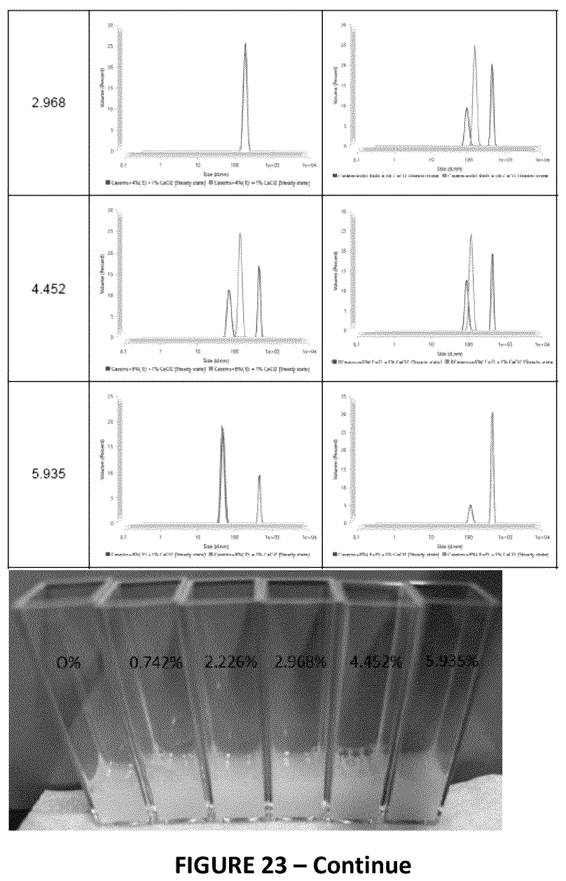

Further, the inventors sought to examine whether plant material interacts with caseins, such that it affects micellization. For this, the inventors performed an ITC study of interactions between mixture of: individual caseins (4:4:1) and any one of the following: (a) buffer only; (b) saturated solution of calcium phosphate; (c) 1% lettuce extract; and (d) 2% Noga lettuce extract. Significant interactions were observed in the presence of a saturated calcium phosphate solution, and the 2% lettuce extract (FIG. 14). Further, the inventors showed that the highest percentage of lettuce extract that can be added to the solution without interfering with the micellization reaction is 3% (FIG. 22). Furthermore, the inventors showed, using DLS studies, that the highest percentage of oat extract that can be present in the solution without interference is the same as for the lettuce extract (3%) (FIG. 23).

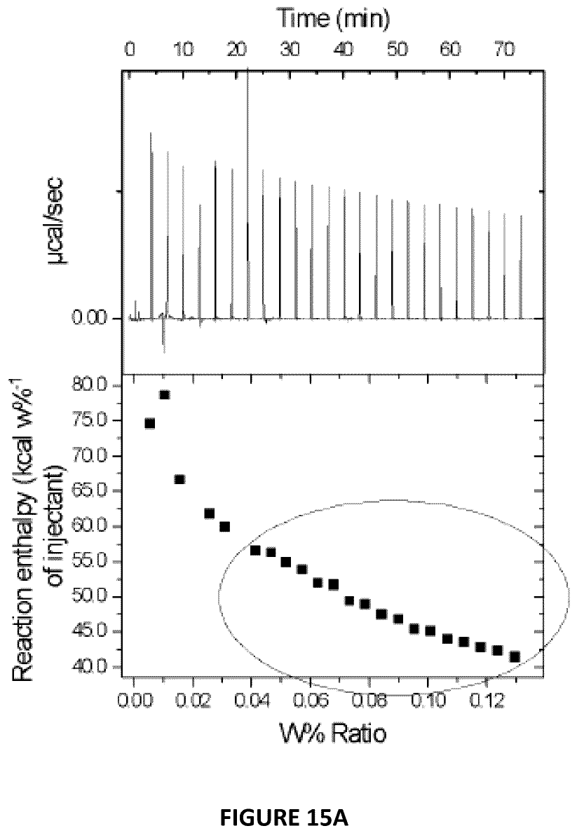

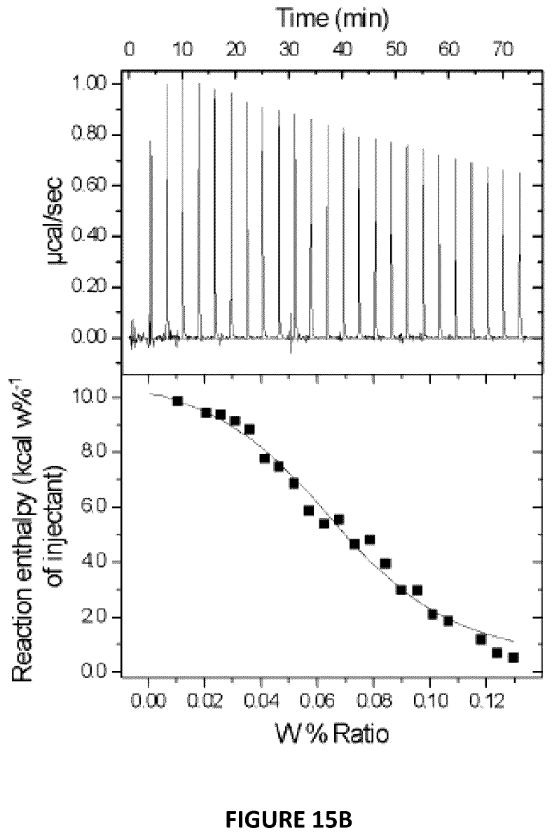

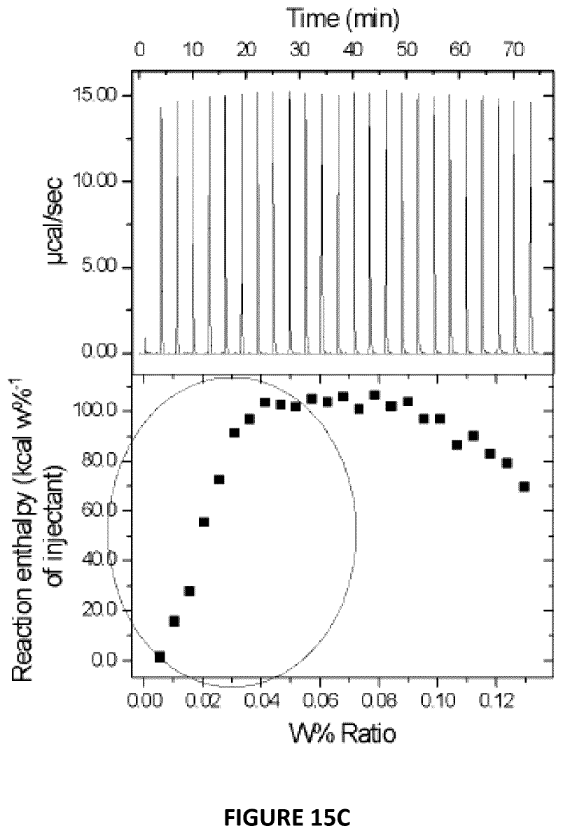

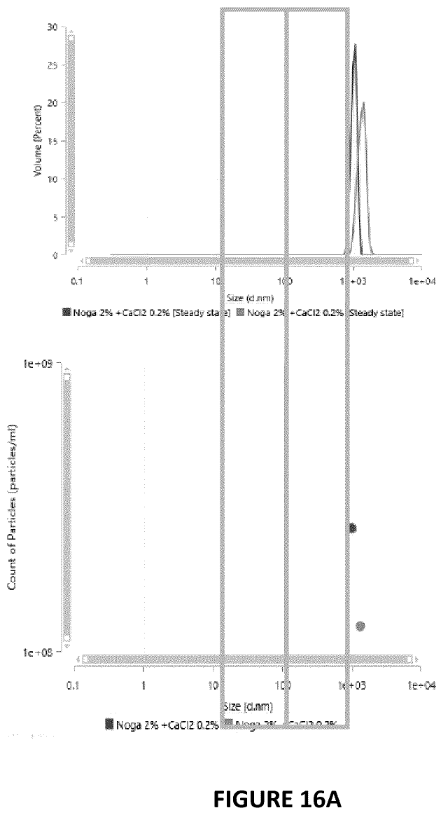

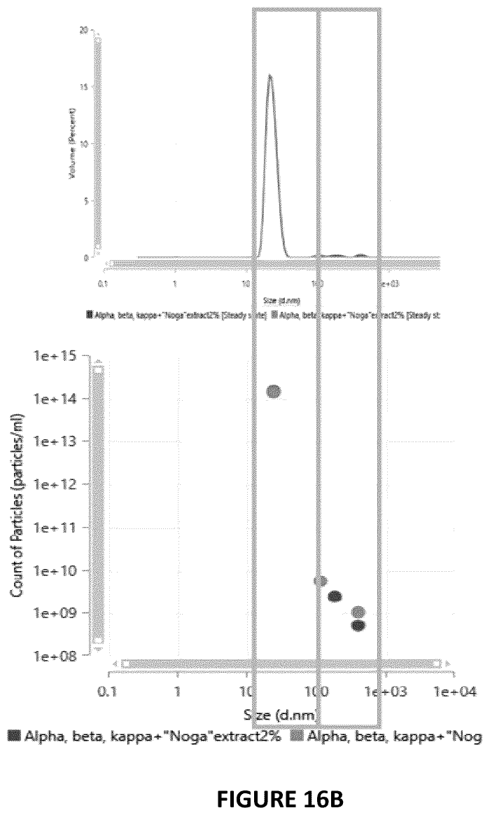

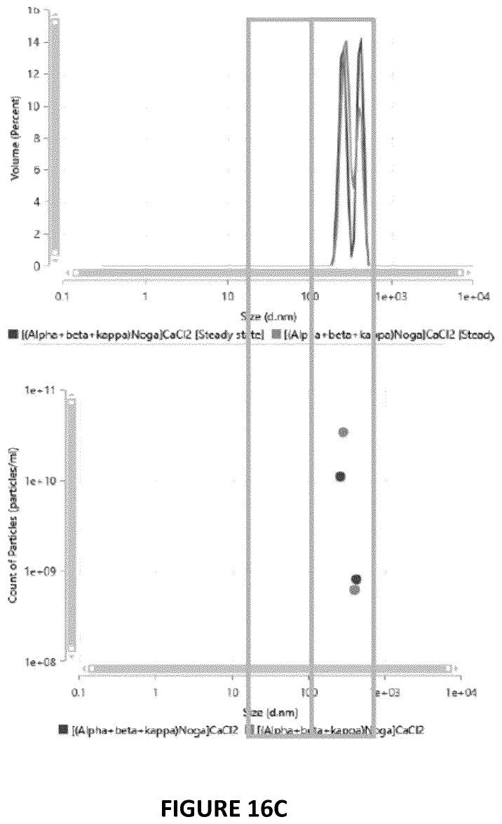

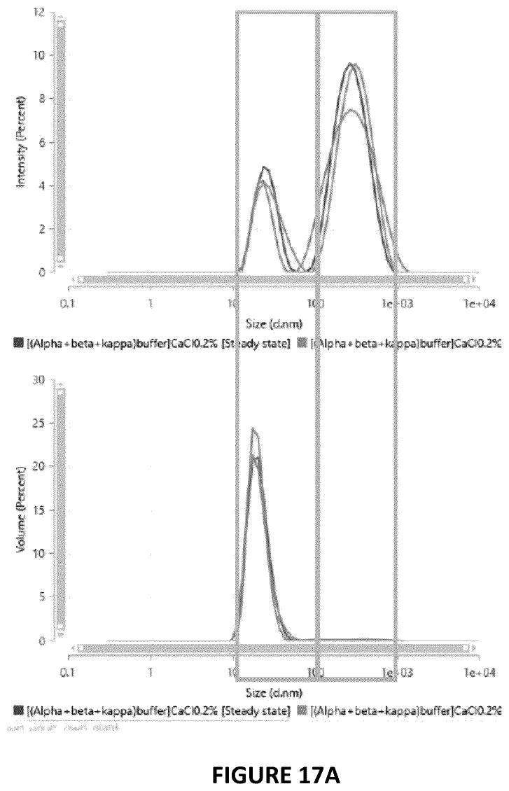

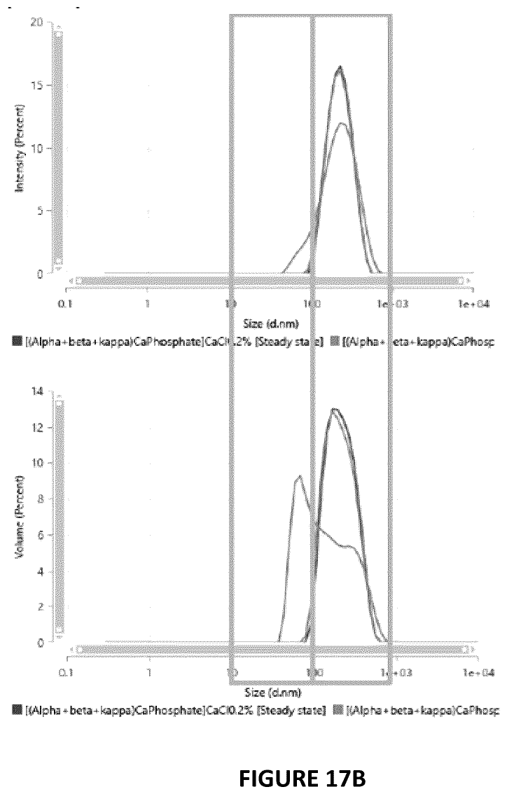

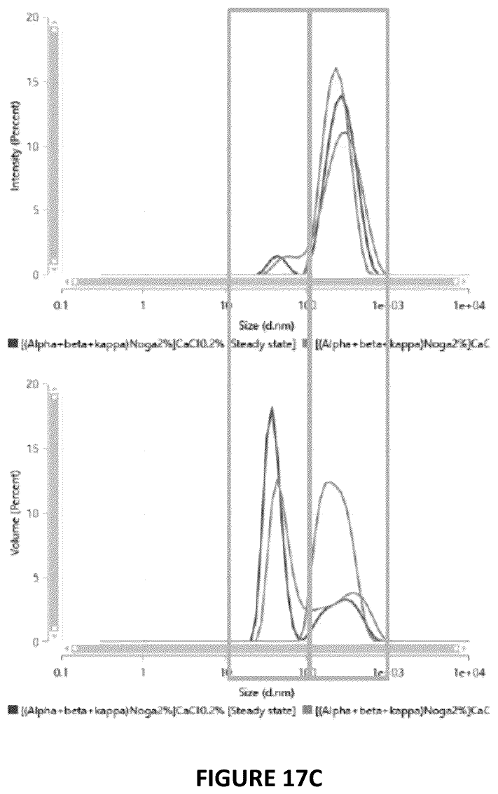

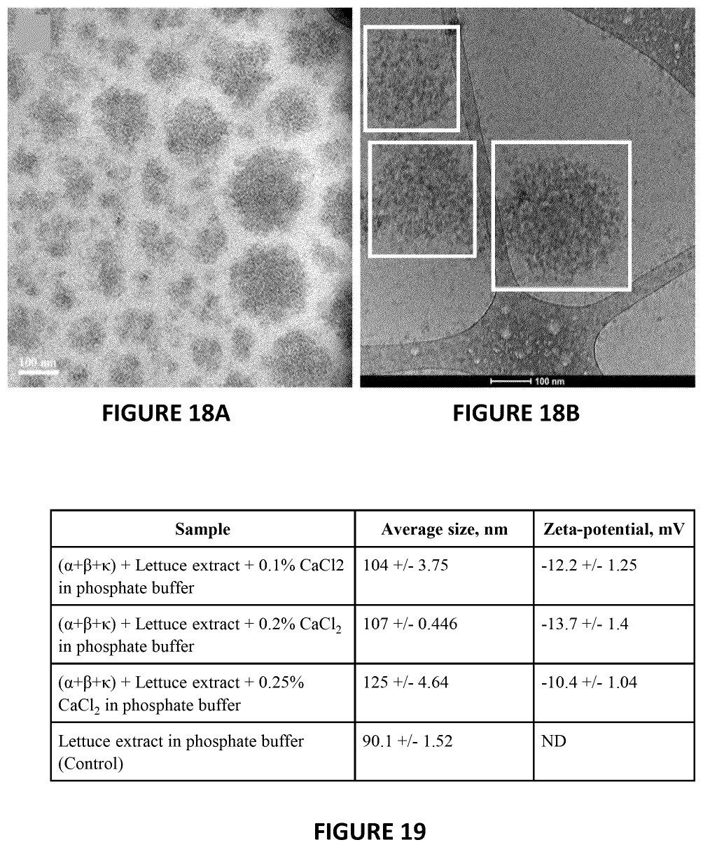

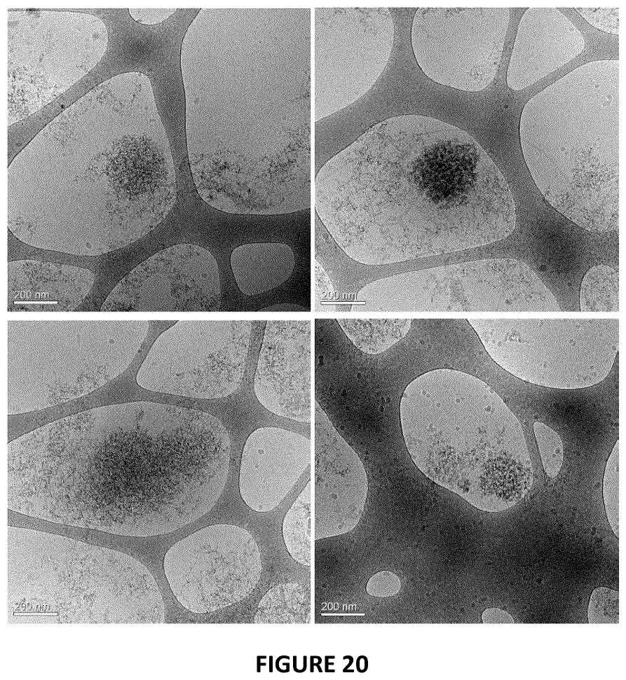

Production of micelles comprising all four caseins as disclosed herein, in the presence of plant material (e.g., lettuce extract, and oat extract), and calcium salt(s) having proper particle size and volume was demonstrated according to ITC and DLS analyses (FIGS. 15-17). Further, using cryo-TEM the inventors have shown formation of casein micellization in lettuce extract with addition of calcium chloride that is equivalent to micelle of native bovine milk having an average size 200-250 nm (FIG. 18). To the best of the inventors knowledge, this is a first-time evidence for casein micelle formation from individual caseins in vitro in the presence of plant extract.

### Conclusions

To this end, any amino acid chain of any sequence or length will inherently undergo agglomeration at some point and conditions, depending on the concentration, pH etc., thereby giving rise to agglomerate-like structure. Accordingly, co-expressing a plurality of proteins in a cell, such as casein proteins, is likely to provide agglomerated structures, including the plurality of the casein proteins. Nonetheless, it would be apparent to a skilled artisan that agglomerated structures spontaneously in vivo formed in a plant cell are not the intricate and complexed “milk-like” micelles.

Accordingly, in order to form milk-like micelles further including plant material, the inventors devised the expression of each individual casein protein in a separate plant, to be isolated and mixed ex vivo or in vitro in the presence of plant material, to achieve controllable and proper interaction. Therefore, the inventors have titrated separately expressed αCasein (S1 and S2 combined), β Casein, and κ Casein, in the presence of plant material and found that particular weight per weight ratio of the casein proteins (ranging from 2:2:1 to 6:6:1) was advantageous in the process of achieving properly sized micelles further including plant material.

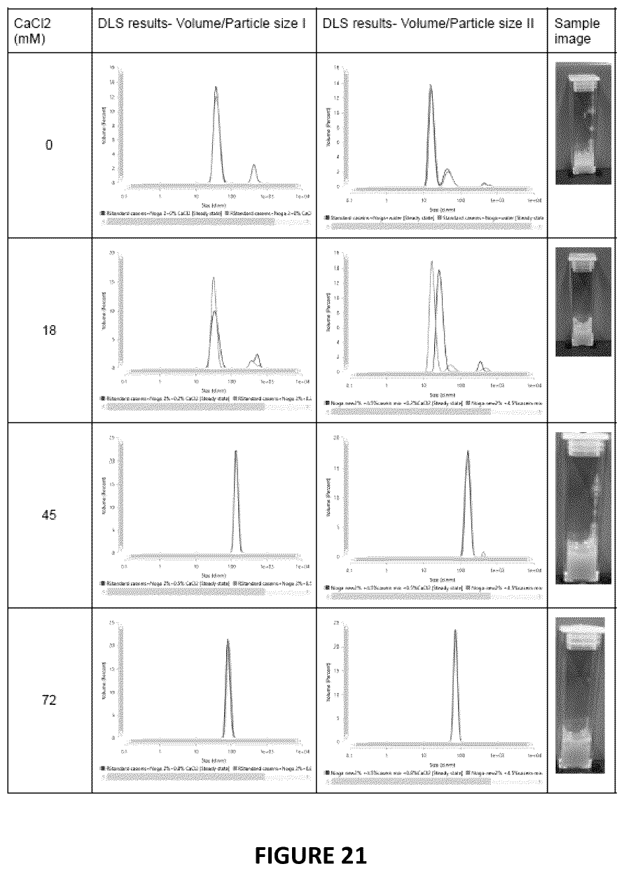

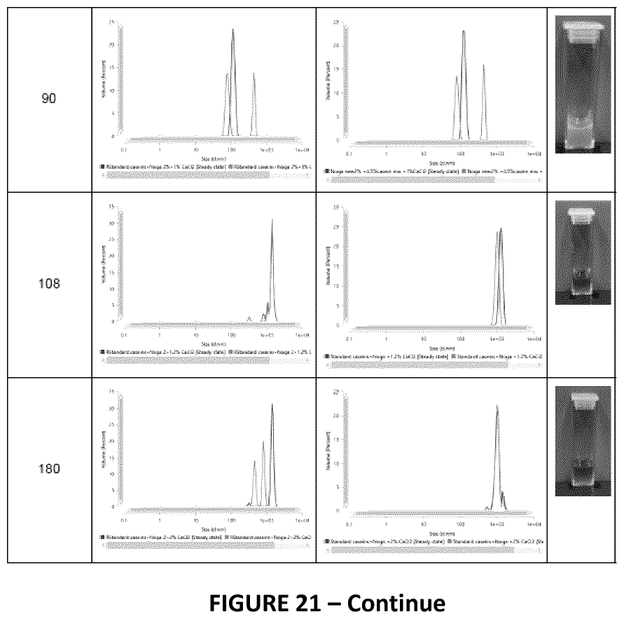

Further, to emphasize the importance of ex vivo or in vitro mixing individually expressed casein proteins in the presence of plant material, the inventors further showed that exogenous supplementation of calcium ions, and specifically calcium chloride at a concentration of 2 mM to 100 mM was advantageous in the process for obtaining “milk-like” micelles, e.g., 100-250 nm on average, and characterized by a zeta potential of −20 mV and −5 mV (FIG. 19). The inventors found that at least 2 mM of CaCl₂ effectively initiated a reaction, whereas above 100 mM sedimentation of calcium was highly evident, thus, ill-advised, as evidenced by a dynamic light scattering (DLS) analysis wherein mostly large insoluble particles likely including protein aggregates, but not micelles, were observed (FIG. 21).

### Example 2: Testing of Analog Low-Moisture Mozzarella

Analog mozzarella was analyzed for functional characteristics such as stretchability using standardized protocols. Various cheese samples were analyzed for their percent protein and percent fat content and stretch length.

Samples were tested by combining water and different concentrations of the dry dairy substitute compositions or plurality of micelles comprising: a plant-based protein (α Casein, B Casein, and κ Casein); a plant derived material; calcium ions; and phosphate ions as described in the disclosure and emulsified using standard or conventional methods. The stretch test utilized a protocol of heating 5 g of sample until it reaches 65° C.-, then using controlled tensile elongation until there was a structural failure of the casein network. To compare characteristics, after having mixed samples for 10 minutes at 45° C. and rested for 1 hour to enable full hydration, each sample was divided into two 100 g samples, where one was directly acidified and the other was exposed to a high dosage of rennet to test coagulation.

For acidification, the sample was heated to 45° C. and modified to pH 5 using vinegar (e.g., 7g). For enzymatic coagulation testing, the sample was heated to 42° C. (which was the optimal temperature for rennet recommended by the manufacturer) and 3 drops of rennet, which is a high dosage, was added e to ensure a reaction. After the samples rested for 30 minutes, they were examined. Further processing of those samples that formed a curd were subsequently performed. The curd samples were strained for 30 minutes and then weighed. The protein percentages affected characteristics of the cheese, such as but not limited to, coagulation, acidification, and curd weight. As the protein percentages increased the samples demonstrated an increase in curd formation/coagulation as well as an increase in curd size/acidification and weight.

The fat percentage and its effect on characteristics of cheese were also analyzed. Each sample contained 13% of the dry dairy substitute composition or plurality of micelles comprising: a plant-based protein (α Casein, β Casein, and κ Casein); a plant derived material; calcium ions; and phosphate ions as described in the disclosure; 1% lecithin, and different percentages of fat and water. These analog mozzarella cheese samples were analyzed by blending samples for 10 minutes at 45° C., then the samples rested for 30 minutes. Acidification, coagulation, and processing curds forming stretchable cheeses utilized the same techniques as described in the analysis of protein percentage differences. Stretchability was tested on 10 g of each sample heated to 60° C. until the matrix reached the point of breakage. Similar to those trends found with increasing protein percentages in the cheese samples, increasing fat percentages corresponded to increasing stretchability and softer consistencies.

The results of the analog mozzarella were consistent with those of commercially available mozzarella or traditional mozzarella. It was found that at a 13% fat content, in a 1:1 ratio between fat and protein, the analog mozzarella sample had closely aligned characteristics as those of traditional mozzarella.

Lecithin percentages in analog low moisture mozzarella were tested for its properties of fortifying and strengthening emulsions and improving meltability of the final food product of the disclosure. Samples of reconstructed milk were made with the same equipment and the same recipe of 13% of the dry dairy substitute composition or plurality of micelles comprising: a plant-based protein (α Casein, β Casein, and κ Casein); 12% fat; 3% sucrose; and filtered water up to a total of 100%, where the percentage of lecithin is the only difference. The milk was coagulated into a curd and processed according to the low moisture mozzarella recipe of the disclosure. A 5 g sample was taken and heated up to 65° C. and stretched immediately. The stretching stopped before the curd ripped, and the length was measured. The results showed that an increase in percent lecithin corresponded to an increased length or stretch in centimeters. It was found that without lecithin, the emulsion was not sufficiently strong enough to retain fat inside the emulsion. Accordingly, the stretch length was shorter. However, in order to achieve the desired stretch, a balance of the dry dairy substitute composition or plurality of micelles comprising: a plant-based protein (α Casein, β Casein, and κ Casein) attached to water and fat was necessary to provide the desired elasticity. The conclusion was that lecithin assists in binding protein, fat, and water into a cohesive emulsion, thereby contributing to the desired stretch in analog cheeses of the disclosure. The emulsifying property helped stabilize the mixture, thereby ensuring a uniform texture and enhancing the meltability and stretchability of the analog food product.

pH levels in analog low moisture mozzarella were tested for its curdling properties, which is associated with the acidity level of traditional mozzarella, thereby ensuring an ideal texture, water-holding capacity (WHC), and functionality of the final food product of the disclosure. Samples of reconstructed milk were made with the same equipment and the same recipe of 13% of the dry dairy substitute composition or plurality of micelles comprising: a plant-based protein (α Casein, β Casein, and κ Casein); 12% fat; 3% sucrose; 0.5% lecithin; and filtered water up to a total of 100%, where the pH level is the only difference. The milk was coagulated into a curd and processed according to the low moisture mozzarella recipe of the disclosure. Samples of 100 g were produced at a temperature of 42° C. and gently titrated with 5% vinegar until the desired pH levels were achieved. The samples were rested for 10 minutes and examined. The results showed that a desirable pH level for curdling was found at pH 5, which aligned with the acidity level of traditional mozzarella, and ensured the ideal texture, water-holding capacity (WHC), and functionality. The pH level of pH 5-pH 5.5 promoted proper protein aggregation and moisture retention, which are important for achieving the desired stretch and melt properties of mozzarella.

### Example 3: Starter Culture Low Moisture Mozzarella Process

In order to obtain a clean cheese taste (i.e., less noticeable vinegar taste) and to provide a process similar to those for producing traditional low moisture mozzarella cheese, low moisture mozzarella was produced using a starter culture instead of using an acid, such as vinegar.

All of the ingredients except for the starter culture were weighed and prepared for mixing at a temperature of 45° C. and blended for 2 minutes (i.e., Thermomix, speed level 6) and for 10 minutes at a decreased speed (i.e., Thermomix, speed level 4). The mixture was strained and hydrated overnight. Hydrated milk and starter culture (CHR Hansen STI-12 thermophilic starter culture, 50 U Streptococcus thermophilus) were mixed at the lowest speed (Thermomix) for 5 minutes at 40° C. and then incubated for the various times and at the various temperatures (i.e., 4-6 hours; 37° C.-43° C.) tested here. The resulting curd was strained for 30 minutes. The curd was then covered with hot water at 65° C.-70° C. and kneaded in 30 second intervals. Typically, 2-3 kneading/heating sessions were needed to obtain a smooth texture. Once a ball formed, it was soaked in very cold water for 30 minutes. Then the cheese was removed from water and packed in air-tight packaging. Favorable results from a 4-hour incubation period at 41° C., pH 5.1 provided cheese that had excellent stretchability (i.e., 5 g stretch length of greater than 40 cm (e.g., 42 cm, 45 cm) and sufficient curd weight (i.e., 100 g or greater (e.g., 129 g, 133 g). Although the starter culture process resulted in the desired functional properties, which aligned with traditional mozzarella characteristics.

It was also found that sodium citrate could be used to enhance the stretch of cheeses such as but not limited to mozzarella. This occurs by chelating calcium ions (Ca²⁺) thereby disrupting cross linkages between casein micelles. Calcium was found to strengthen the protein network and reduce elasticity. By sequestering calcium ions, sodium citrate softened the matrix thereby improving meltability and stretchability.

Experiments demonstrated that stretchability and water retention had improved with the addition of trisodium citrate (0.3 g), specifically enabling a stretch length of up to 74 cm and increased curd yield to approximately 66.9% of the total mass (800 g curd from 1196.8 g total) compared to 43.8% of the total mass (220 g curd from 502.5 g total). This indicated improved water retention and integrity. These results aligned with the expected role of sodium citrate in disrupting calcium-mediated protein cross-linkages, which improved elasticity and hydration. The data confirmed that sodium citrate effectively enhanced stretch and water-holding capacity in the plant-based casein micelle system of the disclosure.

While the embodiments of the present disclosure have been particularly described, persons skilled in the art will appreciate that many variations and modifications can be made. Therefore, the embodiments of the disclosure are not to be construed as restricted to the particularly described embodiments, and the scope and concept of the invention will be more readily understood by reference to the claims which follow.

### SPECIFIC EMBODIMENTS

Non-limiting specific embodiments are described below each of which is considered to be within the present disclosure.

Embodiment 1. A composition comprising:
a dry dairy substitute composition,
wherein the dry dairy substitute composition comprises:
a plurality of micelles,
   wherein each of the plurality of micelles comprises:
      a plant-based protein,
         wherein the plant-based protein comprises:
         α Casein,
         β Casein, and
         κ Casein;
   a plant derived material;
   calcium ions; and
   phosphate ions.

Embodiment 2. The composition of embodiment 1, wherein said plant-based protein of comprising α Casein, β Casein, and κ Casein, is present in said composition in a weight per weight ratio (w/w) of between 1:1:1 to 10:10:1.

Embodiment 3. The composition of embodiment 1 or 2, wherein said α Casein comprises: αS1 Casein, αS2 Casein, or both.

Embodiment 4. The composition of embodiment 3, wherein said α Casein comprising αS1 Casein and αS2 Casein is present in said composition in a weight per weight ratio (w/w) of between 3:1 to 1:3.

Embodiment 5. The composition of any one of embodiments 1 to 4, wherein said plant derived material comprises an extract, a homogenate, any fraction thereof, or any combination thereof, being derived from a plant.

Embodiment 6. The composition of any one of embodiments 1 to 5, wherein said calcium ions are in a concentration ranging from 2 mM to 100 mM

Embodiment 7. The composition of embodiment 6, wherein said calcium ions are CaCl₂.

Embodiment 8. The composition of any one of embodiments 1 to 7, wherein the phosphate ions are phosphate ions, polyphosphate ions, or a combination thereof.

Embodiment 9. The composition of any one of embodiments 1 to 8, further comprising at least one ion selected from the group consisting of: Zn²⁺, Mg²⁺, Cu²⁺, Na⁺, K⁺, Fe²⁺, Fe³⁺, and any combination thereof.

Embodiment 10. The composition of any one of embodiments 1-9, wherein said plurality of micelles is characterized by an average particle size ranging between 100 nm and 250 nm, 300 nm and 500 nm, or both.

Embodiment 11. The composition of any one of embodiments 1-10, wherein said plurality of micelles is characterized by any one of: having size, average size, or maximal size, diameter, average diameter, or maximal diameter, taste, flavor, scent, organoleptic properties, or any combination thereof, being at least 90% identical to milk micelles.

Embodiment 12. A method for preparing the composition of any one of embodiments 1 to 11, the method, comprising:
combining:
   plant-based proteins of α Casein, β Casein, and κ Casein;
   the plant derived material;
   calcium ions; and
   phosphate ions, thereby forming a combination of plant-based proteins, plant-derived material, and ions;
purifying the combination, thereby forming a purified combination; and
drying the purified combination, thereby forming the plurality of micelles of the composition.

Embodiment 13. The method of embodiment 12, wherein combining the plant-based proteins of α Casein, β Casein, and κ Casein in a weight per weight ratio (w/w) of between 2:2:1 to 6:6:1.

Embodiment 14. The method of any one of embodiments 12 to 13, further comprising combining at least one ion selected from the group consisting of: Zn²⁺, Mg²⁺, Cu²⁺, Na⁺, K⁺, Fe²⁺, Fe³⁺, and any combination thereof.

Embodiment 15. The method of any one of embodiments 12 to 14, wherein combining occurs under at least one condition selected from the group consisting of: heat, cooling, sonication, electrolysis, and any combination thereof.

Embodiment 16. A method of producing an analog food product,
wherein the analog food product is analog low moisture mozzarella cheese,
wherein the method comprises:
   mixing: the dry dairy substitute composition of any one of embodiments 1 to 11, water, a fat, and an emulsifier to total 100%, and
   adding an acid and a base to the mixture,
   adjusting pH to a range of pH 5-pH 5.5,
      thereby producing the analog low moisture mozzarella cheese.

Embodiment 17. A method of producing an analog food product,

wherein the analog food product is analog feta cheese,
wherein the method comprises:
   mixing: the dry dairy substitute composition of any one of embodiments 1 to 11, water, a sugar, and a fat to total 100%, and
   adding and mixing a blend of mesophilic cultures and thermophilic cultures, rennet, and calcium ions to the mixture,
      thereby producing the analog feta cheese.

Embodiment 18. A method of producing an analog food product,

wherein the analog food product is analog haloumi cheese,
wherein the method comprises:
   mixing: the dry dairy substitute composition of any one of embodiments 1 to 11, water, a fat, and a sugar to total 100%, and
   adding and mixing rennet, mesophilic cultures, and calcium ions to the mixture,
      thereby producing the analog haloumi cheese.

Embodiment 19. The method of embodiment 16, wherein the acid is selected from the group consisting of buttermilk, citric acid, cream of tartar, lemon juice, vinegar, yogurt, and any combinations thereof.

Embodiment 20. The method of embodiment 16, wherein the base is selected from the group consisting of sodium citrate, sodium hydroxide, sodium polyphosphate, and any combinations thereof.

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

What is claimed is:

1. A composition comprising:
a dry dairy substitute composition,
wherein the dry dairy substitute composition comprises:
a plurality of micelles,
wherein each of the plurality of micelles comprises:
a plant-based protein,
wherein the plant-based protein comprises:
α Casein,
β Casein, and
κ Casein;
a plant derived material;
calcium ions; and
phosphate ions.

2. The composition of claim 1, wherein said plant-based protein of comprising α Casein, β Casein, and κ Casein, is present in said composition in a weight per weight ratio (w/w) of between 1:1:1 to 10:10:1.

3. The composition of claim 1, wherein said α Casein comprises: αS1 Casein, αS2 Casein, or both.

4. The composition of claim 3, wherein said α Casein comprising αS1 Casein and αS2 Casein is present in said composition in a weight per weight ratio (w/w) of between 3:1 to 1:3.

5. The composition of claim 1, wherein said plant derived material comprises an extract, a homogenate, any fraction thereof, or any combination thereof, being derived from a plant.

6. The composition of claim 1, wherein said calcium ions are in a concentration ranging from 2 mM to 100 mM.

7. The composition of claim 6, wherein said calcium ions are CaCl₂.

8. The composition of claim 1, wherein the phosphate ions are phosphate ions, polyphosphate ions, or a combination thereof.

9. The composition of claim 1, further comprising at least one ion selected from the group consisting of: Zn²⁺, Mg²⁺, Cu²⁺, Na⁺, K⁺, Fe²⁺, Fe³⁺, and any combination thereof.

10. The composition of claim 1, wherein said plurality of micelles is characterized by an average particle size ranging between 100 nm and 250 nm, 300 nm and 500 nm, or both.

11. The composition of claim 1, wherein said plurality of micelles is characterized by any one of: having size, average size, or maximal size, diameter, average diameter, or maximal diameter, taste, flavor, scent, organoleptic properties, or any combination thereof, being at least 90% identical to milk micelles.

12. A method for preparing the composition of claim 1, the method, comprising:
combining:
plant-based proteins of α Casein, β Casein, and κ Casein;
the plant derived material;
calcium ions; and
phosphate ions, thereby forming a combination of plant-based proteins, plant-derived material, and ions;
purifying the combination, thereby forming a purified combination; and
drying the purified combination, thereby forming the plurality of micelles of the composition.

13. The method of claim 12, wherein combining the plant-based proteins of α Casein, β Casein, and κ Casein in a weight per weight ratio (w/w) of between 2:2:1 to 6:6:1.

14. The method of claim 12, further comprising combining at least one ion selected from the group consisting of: Zn²⁺, Mg²⁺, Cu²⁺, Na⁺, K⁺, Fe²⁺, Fe³⁺, and any combination thereof.

15. The method of claim 12, wherein combining occurs under at least one condition selected from the group consisting of: heat, cooling, sonication, electrolysis, and any combination thereof.

16. A method of producing an analog food product,
wherein the analog food product is analog low moisture mozzarella cheese,
wherein the method comprises:
mixing: the dry dairy substitute composition of claim 1, water, a fat, and an emulsifier to total 100%, and
adding an acid and a base to the mixture,
adjusting pH to a range of pH 5-pH 5.5,
thereby producing the analog low moisture mozzarella cheese.

17. A method of producing an analog food product,
wherein the analog food product is analog feta cheese,
wherein the method comprises:
mixing: the dry dairy substitute composition of claim 1, water, a sugar, and a fat to total 100%, and
adding and mixing a blend of mesophilic cultures and thermophilic cultures, rennet, and calcium ions to the mixture,
thereby producing the analog feta cheese.

18. A method of producing an analog food product,
wherein the analog food product is analog haloumi cheese,
wherein the method comprises:
mixing: the dry dairy substitute composition of claim 1, water, a fat, and a sugar to total 100%, and
adding and mixing rennet, mesophilic cultures, and calcium ions to the mixture,
thereby producing the analog haloumi cheese.

19. The method of claim 16, wherein the acid is selected from the group consisting of buttermilk, citric acid, cream of tartar, lemon juice, vinegar, yogurt, and any combinations thereof.

20. The method of claim 16, wherein the base is selected from the group consisting of sodium citrate, sodium hydroxide, sodium polyphosphate, and any combinations thereof.
